(19) United States
(12) Patent Application Publication
(10) Pub. No.: US 2022/0266722 A1
(43) Pub. Date: Aug. 25, 2022

(54) FIXING DEVICE FOR FIXING AN OBJECT IN A VEHICLE IN A MANNER ACTUATED BY EXTERNAL FORCE WITH THE AID OF AT LEAST ONE SEPARATELY ADJUSTABLE LOCKING ELEMENT

(71) Applicant: Brose Fahrzeugteile SE & Co. Kommanditgesellschaft, Coburg, Coburg (DE)

(72) Inventors: Markus BAUERNFEIND, Coburg (DE); Mario WAZANINI, Steinsdorf (DE); Fabian LANG, Markt Nordheim (DE); Michael HÖPPEL, Bad Staffelstein (DE); Markus TREICHL, Meeder (DE); Mario STEGERER, Gundelsheim (DE); Stefan BÄTZ, Meeder (DE); Volker DEINHARD, Bamberg (DE); Eike FRÖHLICH, Bamberg (DE); Christian HERZOG, Zeil am Main (DE); Hartmut BEYERSDORFER, Coburg (DE)

(73) Assignee: Brose Fahrzeugteile SE & Co. Kommanditgesellschaft, Coburg, Coburg (DE)

(21) Appl. No.: 17/629,235

(22) PCT Filed: Jul. 17, 2020
(86) PCT No.: PCT/EP2020/070290

§ 371 Date: Jan. 21, 2022

(30) Foreign Application Priority Data
Jul. 22, 2019 (DE) 10 2019 210 835.0
Jul. 22, 2019 (DE) 10 2019 210 837.7
Aug. 29, 2019 (DE) 10 2019 213 012.7
Aug. 30, 2019 (DE) 10 2019 123 369.0
Sep. 17, 2019 (DE) 10 2019 214 152.8
Mar. 11, 2020 (DE) 10 2020 203 151.7

(51) Int. Cl. B60N 2/015; B60N 2/02; B60N 2/01

(52) U.S. Cl. CPC B60N 2/0155; B60N 2/0232; B60N 2/01; B60N 2002/0264; B60K 2001/0405

(57) ABSTRACT

A fixing device for fixing an object to a fixing surface in a vehicle, including at least one fixing element configured for fixing the object with a fixing portion that is provided for engagement in a fixing opening, the fixing portion can be introduced into the fixing opening along an adjustment axis. At least one adjustable locking element, separate from the fixing element, which by interaction with the fixing portion engaging in the fixing opening locks the fixing element on the fixing opening and blocks the fixing portion against removal from the fixing opening.

### CROSS-REFERENCE TO RELATED APPLICATIONS

This application is the U.S. National Phase of PCT Application No. PCT/EP2020/070290 filed on Jul. 17, 2020, which claims priority to German Patent Application No. DE 10 2019 210 837.7, filed on Jul. 22, 2019, DE 10 2019 210 835.0 filed Jul. 22, 2019, DE 10 2019 213 012.7, filed Aug. 29, 2019, DE 10 2019 123 369.0, filed Aug. 30, 2019, DE 10 2019 214 152.8, filed Sep. 17, 2019, and DE 10 2020 203 151.7, filed Mar. 11, 2020, the disclosures of which are hereby incorporated in their entirety by reference herein.

### TECHNICAL FIELD

The present disclosure relates to a fixing device for fixing an object to a fixing surface in a vehicle.

### BACKGROUND

Vehicles generally include a cabin or vehicle interior, and it may be desirable to fix one or more objects to a fixing surface formed by the vehicle interior. The fixing surface for example can be a loading area of the vehicle interior, to which interior objects, e.g. in the form of vehicle seats, tables and/or center consoles, can be fixed.

### SUMMARY

One or more objects underlying the present disclosure may be to provide an improved flexible arrangement of an object on a fixing surface in a vehicle is improved.

According to one or more embodiments, a fixing device for fixing an object to a fixing surface in a vehicle, which may include at least one fixing element that is configured for fixing the object by means of a fixing portion that is provided for engagement in a fixing opening. The fixing portion can be introduced into the fixing opening along an adjustment axis. At least one adjustable locking element of the fixing device, which is separate from the fixing element, locks the fixing element on the fixing opening by interaction with the fixing portion engaging in the fixing opening and blocks the fixing portion against removal from the fixing opening.

Thus, the proposed solution proceeds from the fundamental idea to provide at least one adjustable locking element in addition to a fixing portion displaceable along an adjustment axis, which itself is adjustable. The locking element is not adjustably mounted on the fixing element itself, but can only get in engagement with the fixing portion of the fixing element when the fixing portion has been properly introduced into the fixing opening. In principle, it is irrelevant here whether the fixing element is provided on the side of the object or on the side of the fixing surface and whether, conversely, the at least one locking element is provided on the side of the fixing surface or on the side of the object. It rather is decisive that two separately adjustable elements (fixing element and locking element) and hence also two separate adjusting movements are provided in order to ensure a fixation of an object to a fixing surface. Correspondingly, the two different adjusting movements of the fixing element with its fixing portion on the one hand and of the locking element on the other hand, are adjusted to each other, but in principle are controllable independently of each other (manually or by external force).

In one or more embodiments, the at least one locking element is adjustable into a locking position for locking the fixing element, in which the at least one locking element is positively connected to the fixing portion. The positive connection possibly can also involve a non-positive connection. Via the positive connection between the locking element and the fixing portion, a more effective blocking effect and hence securement of the fixing portion in the fixing opening can be achieved. For locking the fixing element on the fixing opening, the locking element consequently can be brought into positive engagement with the fixing portion by adjusting the at least one locking element into its locking position.

For the positive connection, an engagement area can be provided on the fixing portion, which with respect to areas of the fixing portion adjacent to the engagement area is formed to be radially set back inwardly, with respect to the adjustment axis. In one or more embodiments, the at least one locking element then gets in engagement with this engagement area for locking the fixing element on the fixing opening. The set-back engagement area can be formed on the fixing portion for example by a groove, such as by an annular groove extending around the adjustment axis.

For locking with the fixing portion introduced into the fixing opening, the at least one locking element can be rotatably mounted about an axis of rotation extending parallel or perpendicularly to the adjustment axis of the fixing portion. The locking element then for example forms part of a bayonet lock or a pivotable bracket portion in order to fix the fixing portion to the fixing opening. The fixing portion for example can dip into a rotary body formed by the locking element below or on the fixing opening, which rotary body ensures an arrestment of the fixing portion by rotation about the axis of rotation parallel to the adjustment axis. For example, the rotary body can be configured in the form of a nut that engages behind a radially protruding pin or web at the fixing portion during a rotation and thereby positively locks the fixing portion. A corresponding rotation of the rotary body, such as of the nut formed thereby, for example can amount to 270°. Alternatively, when being introduced into the fixing opening, the fixing portion can act on a portion of a rotatably mounted locking element configured with a curved bracket portion, in order to bring the bracket portion into positive engagement with the fixing portion by a pivotal movement of the locking element.

In another embodiment, the at least one locking element is shiftably mounted along an adjustment direction extending transversely to the adjustment axis of the fixing portion. Consequently, when the fixing portion is introduced into the fixing opening along the adjustment axis, a displacement of the locking element transversely to the direction of introduction of the fixing portion subsequently is effected—when the fixing portion has taken a specified introduction position.

For example, the at least one locking element may include a shiftably mounted carriage. For shiftably mounting the carriage, for example a physical guide can be provided. For example, at least one guide rail is provided, on which the carriage is shiftably mounted.

As an example, the carriage can be manually shiftable so that an object fixation can be manually implemented by a user. Alternatively, a motorized drive device can be provided for a power-operated adjustment of the carriage. In one or more embodiments, for example, a spindle drive is provided for the adjustment of the carriage.

For the secure locking of the fixing portion on the fixing opening by the shiftable carriage, one or more embodiments provides that on the carriage a locking opening is provided, in which the fixing portion of the fixing element introduced into the fixing opening engages. In this way, the carriage can be shifted along the adjustment direction from a release position into a locking position in which the fixing portion is arrested on the locking opening of the carriage. For example, the locking opening includes first and second opening portions, wherein in the release position of the carriage the fixing portion of the fixing element can be introduced into the locking opening at the first opening portion and subsequently the second opening portion of the locking opening can be brought in engagement with the fixing portion of the locking element by a displacement of the carriage along the adjustment direction. The opening portions of the locking opening here can have different dimensions and for example jointly define a key-hole-shaped (opening) contour. Thus, while the first (larger) opening portion permits the introduction of the fixing portion into the locking opening of the carriage present in the release position, the other second (smaller) opening portion is dimensioned in such a way that the fixing portion no longer can be retracted from the locking opening and hence from the fixing opening along the adjustment axis.

To support an arrestment of the fixing portion on the at least one locking element as backlash-free as possible, one or more embodiments provides that the carriage is elastically pretensioned in the adjustment direction, i.e. especially in that direction in which the carriage is to be adjusted for locking the fixing element to the fixing opening. For elastically pretensioning, there can be provided at least one spring element which acts upon the carriage, for example, pushes or pulls the same, with a pretensioning force acting in the direction of a locking position.

In one or more embodiments, the carriage is elastically pretensioned via at least one spring element which on the one hand is supported on a part of the carriage and on the other hand on a support part adjustable in the adjustment direction. The support part consequently can likewise be adjusted in the adjustment direction, for example in that it is drivable itself or forms part of a base carrying the carriage. At the same time, the carriage is held so as to be displaceable relative to the support part and is additionally pretensioned into the adjustment direction via the at least one spring element. For locking the fixing portion introduced into the fixing opening, the support part consequently is adjusted in the first adjustment direction together with the carriage, for example by means of a motorized drive. In a locking position then taken, the carriage is additionally loaded into the adjustment direction and hence into the locking position, in which the carriage is in positive engagement with the fixing portion, via the at least one spring element supported on the support part.

As an example, the at least one locking element can include at least one clamping portion via which the fixing element with its fixing portion introduced into the fixing opening is displaceable along the adjustment axis into a tensioning position. Thus, via the clamping portion of the locking element an even if only slight displacement of the fixing portion can be achievable in order to keep the fixing element under tension, when it is properly fixed on the fixing opening via the at least one locking element and is blocked against a displacement out of the fixing opening. In this way, for example a backlash-free and/or rattle-free locking on the fixing opening can easily be ensured and a possibly desired contact pressure can be applied onto the object to be fixed in the direction of the fixing surface.

For example, the clamping portion includes a ramp area extending with an inclination to the adjustment axis of the fixing element, which is adjustable along an engagement area of the fixing portion of the fixing element introduced into the fixing opening. Then, during an adjustment of the locking element into its locking position, the ramp area then displaces the fixing element into the tensioning position by sliding along the engagement area. Then, for example, the ramp area extending with an inclination to the adjustment axis is guided along a portion, for example, web, pin or shoulder of the fixing portion protruding radially to the adjustment axis, and urges the fixing portion into the tensioning position along the original direction of introduction. The fixing portion thereby is loaded into the tensioning position by the ramp area.

In one or more embodiments, a counter-element is part of the fixing device, which contacts the fixing portion when the same is introduced into the fixing opening. The counter-element can be adapted and provided for example to produce an electrical connection with the fixing portion. As an example, it can be provided in this connection that a connector (plug or socket) is provided on the counter-element. With respect to the counter-element, the fixing portion as a counterpart for the provision of the electrical connection in one or more embodiments can be centered via the locking element on engagement in the fixing opening. As an example, the locking element thus is additionally adapted to align the fixing portion with respect to the counter-element so that the fixing portion and the counter-element come in contact with each other undisturbed, in order to provide the electrical connection.

Alternatively or additionally, the counter-element is adjustably mounted in order to at least partly close the fixing opening in a closed position and clear the same only by introduction of the fixing portion. In the latter variant, the counter-element consequently can be displaced out of its closed position by the fixing portion introduced into the fixing opening. When the fixing portion is removed from the fixing opening in order to be able to (again) displace the object, the fixing opening can again be closable automatically via the counter-element, for example in that the counter-element is elastically pretensioned into a closed position. For this purpose, a compression spring for example engages the counter-element so that the counter-element in its closed position closes the fixing opening on the fixing surface or the object with a closure portion. Consequently, the counter-element can be provided on the side of the fixing surface or on the side of the object. The fixing element with its fixing portion introduced into the fixing opening then respectively can displace the counter-element from its closing position into another adjustment position.

In one or more embodiments, in which a counter-element provided for producing an electrical connection in addition is also adjustably mounted, the electrical connection between the fixing portion and the counter-element can be produced only by the displacement of the counter-element out of its closed position. Thus, in such a variant an electrical connection via the counter-element present in its closed position is not (yet) possible. Rather, the counter-element must first be displaced out of the closed position in order to be able to provide an electrical connection. Such an electrical connection for example provides for controlling and/or charging electronic components provided on the object.

In one or more embodiments, a contact element on the counter-element for example becomes accessible by displacement of the counter-element out of its closed position for producing the electrical connection. Only with the proper and sufficient introduction of the fixing portion into the fixing opening is this contact element accessible for example in such a way that the electrical connection can be produced. As an example, it can be provided that for producing the electrical connection the contact element of the counter-element must first be introduced into a sleeve-shaped portion of the fixing portion. Then, for example, a sleeve-shaped sheathing of the counter-element is displaced by the fixing element introduced into the fixing opening with its fixing portion and thereby a centrally disposed pin-shaped contact element (in the form of a core) is exposed. A likewise sleeve-shaped portion of the fixing portion then is put over this contact element. An electrical plug connection thereby can be provided when the fixing portion has been properly introduced into the fixing opening and has been locked thereon.

A proposed fixing device can be provided for example, for fixing an object to a body-mounted fixing surface in a vehicle, wherein the fixing device can be provided on the fixing surface or on the object itself. For example, for a symmetrical force distribution and a crash-proof locking of the object, a plurality of fixing elements are provided, which each have a displacer element longitudinally adjustable in or on the same. For example, one design variant provides that on the side of the object four fixing elements are arranged in order to fix the object on four fixing openings in a fixing position taken.

In one or more embodiments, the fixing element itself is not of the adjustable type. For example, the fixing element is immovably and rigidly provided on the object. To correspondingly introduce the object-side fixing element into a fixing opening, the object with the fixing element protruding from an underside for example is plugged into an appropriate position on the fixing surface. Alternatively, motor-controlled or manual lowering of the object in the direction of the fixing surface can be provided in order to bring the fixing element into engagement with a fixing opening. For example, the object here is adapted and provided to be able to take two different positions with respect to the fixing surface. The object for example can be adjustable, for example, adjustable in a motor-controlled way, on the fixing surface in a first position in which the fixing element is spaced apart from the fixing surface. When a desired fixing position is reached, the object can be lowered in the direction of the fixing surface into a second position, whereby the fixing element (and possibly even further fixing elements provided on the object) is/are inserted into a corresponding fixing opening on the fixing surface—which then is located opposite the fixing element.

One or more embodiments provides that the at least one object is configured as an interior object and may include at least one battery-operated motorized drive device for a non-mechanically guided displacement of the interior object on an interior surface of the vehicle serving as a fixing surface. The at least one fixing element then is provided for the fixation of the at least one interior object in a fixing position on the interior surface, wherein the reaching of this fixing position can be detectable by an electronic detection device of the vehicle.

Via the at least one battery-operated motorized drive device, the at least one interior object can be displaced on the interior surface in a non-track-guided way. Hence, there is not provided a guidance or specification of a path of displacement for the interior object by a rail, a track or a slotted link. Rather, the interior object is freely displaceable on the interior surface. Alternatively, however, the object to be fixed, for example, the interior object, can also be manually displaceable to a desired fixing position.

The fixing positions at which the interior object can be fixed to the interior surface by means of the at least one fixing element can be specified on the interior surface. For example, a multitude of possible fixing positions on the interior surface are predefined. Via the at least one detection device it can be electronically detectable when the interior object has reached a specified fixing position in order to then trigger an adjustment of the at least one fixing element into its fixing position and thereby fix the interior object at the fixing position reached.

In one or more embodiments, the motorized drive device includes at least one rolling body or a chain for the contact with the interior surface and the displacement of the interior object on the interior surface. A rolling body here for example, is understood to be a roller, a wheel or a tire. Via a corresponding drive device comprising at least one rolling body or a chain, the interior object can be adjusted along the interior surface in a battery-operated way, possibly by remote control and/or by means of the electronic detection device.

In one or more embodiments, the at least one motorized drive device includes an omnidirectional drive. Such an omnidirectional drive permits the adjustment of the interior object along arbitrary directions in a spatial plane on the interior surface. For this purpose, an omnidirectional drive for example includes at least one omniwheel.

Via the at least one fixing element adjusted into its fixing position at a fixing point, the interior object can be fixed to a floor anchorage of the interior surface. Thus, by means of the at least one fixing element present in its fixing position, the interior object then is anchored and locked in a crash-proof way on the side of the vehicle. This for example, includes the fact that a fixing element or a plurality of fixing elements are configured and adapted to anchor the interior object at a fixing position in a crash-proof way and hence secure the interior object against a displacement on the interior surface even under high acceleration forces occurring in the case of a crash.

In principle, the fixing element can be adjustably mounted on the interior object or on the interior surface. For example, in one or more embodiments it is provided that the at that least one fixing element is displaceably provided on the interior object, wherein the fixing element is adjusted into its fixing position when the interior object has reached a specified fixing position. Alternatively or additionally, the at least one fixing element can be arranged on the interior surface, which in its fixing position fixes the interior object present in a properly taken fixing position. As an example, a fixation of the interior object can be provided via a combination of fixing elements adjustably mounted on the interior surface and on the interior object.

On the interior surface, a plurality of possible fixing positions can be specified. In this way, a plurality of different fixing positions are predefined in the vehicle interior for an interior object or for a plurality of interior objects in order to specify a finite number of points on the interior surface, at which an interior object can be properly fixed (in a crash-proof way). Independently of this, an adjustment path for reaching a fixing position is not specified via the battery-operated motorized drive device and can be chosen flexibly, for example, in dependence on the arrangement and/or desired position of one or more other interior objects as well as in dependence on possible obstacles on the interior surface.

The electronic detection device, via which for example a position of the interior object also is detectable during its displacement along the interior surface, one embodiment may include at least one component provided on the interior object. This component can be a passive or active component, i.e. a (passive) component that is detectable by a sensor element of the detection device, or an (active) component that actively sends signals to one or more receivers of the electronic detection device and/or by means of sensors detects at least one measurement quantity representative of the environment of the interior object, via which at least the reaching of a specified fixing position on the interior surface of the vehicle interior can be detected.

The electronic detection device in principle can be adapted to detect the position of the interior object during a displacement on the interior surface
optically (for example by means of infrared) and/or
magnetically and/or
in a sound-based, for example, ultrasound-based way and/or
on the basis of radio waves, for example, on the basis of at least one UWB signal (UWB=ultra-wideband) and/or

on the basis of laser beams, for example, on the basis of a Lidar method (Lidar=light detection and ranging).

In one or more embodiments, the electronic detection device may include at least two sensor elements based on different measurement principles in order to detect the reaching of the fixing position by the interior object. In one embodiment, for example different sensor elements consequently are combined with each other in order to avoid or at least reduce wrong detections. For example, via sensor elements based on different measurement principles the reaching of a fixing position can be detected redundantly, and a fixation via the at least one fixing element merely can be enabled when both sensor elements based on different measurement principles detect the reaching of the fixing position. Alternatively or additionally, sensor elements based on different measurement principles can be provided to detect different paths of displacement or different phases during a displacement of the interior object. For example, a first sensor element can detect a position of the interior object in a first radius around a specified fixing position based on a first measurement principle (and hence possibly based on a first measurement quantity and/or a first resolution), while another, second sensor element can detect a position of the interior object in a second radius around the specified fixing position based on another, second measurement principle (and hence possibly based on another, second measurement quantity and/or another, second resolution), the second radius being smaller than the first radius. The first sensor element thus can serve for rough positioning, while fine positioning can be realized by means of the second sensor element.

A combination of different sensor elements for example, can include a combination of the aforementioned measurement principles (optical, magnetic, sound-based, etc.), on the basis of which the electronic detection device can detect a position of the interior object during the displacement on the interior surface.

In one or more embodiments it is provided that in the fixing position and with the fixing element adjusted into the fixing position an electrical connection is provided between a vehicle-side energy source and the interior object. As an example, an electrical connection, as explained above, can be provided via the fixing element. For this purpose, an object-side fixing element in its fixing position for example is electrically conductively connected to a vehicle-side coupling area on the interior surface or a vehicle-side fixing element in its fixing position is electrically conductively connected to an object-side coupling area. A corresponding electrical connection for example serves for charging at least one energy accumulator of the interior object, for example, a battery of the interior object, and/or for supplying at least one load on or in the interior object. The at least one load for example can comprise a display or an additionally provided, electrically operable drive of the interior object, via which an adjustment part of the interior object is adjustable in a power-operated way. When the interior object for example is a vehicle seat, an additional electrically operable drive can be provided for the adjustment of a headrest, a seat cushion and/or a backrest of the vehicle seat as an adjustment part. Alternatively or additionally, the electrical connection can serve the connection to a vehicle-side bus system, e.g. to transmit signals of a vehicle-side protection and/or restraint system, for example, an airbag system, to the interior object or to transmit signals from the interior object to such a system.

Alternatively or additionally, the interior object can comprise at least one terminal for coupling to an external, vehicle-independent energy source. Such a terminal for example may include a connector for coupling to an electrical energy source so that the interior object can be connected to a power source outside the vehicle and for example an energy accumulator of the interior object can be charged.

Another aspect of the proposed solution relates to a fixing device, in which at least one adjustable locking element separate from the fixing element is provided, which is adapted to engage the fixing portion present in an intermediate position and already engaging in the fixing opening, in order to displace the fixing portion from the intermediate position into a contacting position in which the fixing portion is connected to a counter-element for providing an electrical connection.

The locking element engaging the fixing portion can exert an adjusting force on the fixing portion in order to displace the fixing portion from the intermediate position into the contacting position. The locking element can be adjustable in a power-operated way, for example for example, via a drive that is provided in addition to a drive for the adjustment of the fixing portion. As an example, the fixing portion—and thereby the interior object carrying the fixing element—can be tensionable in the direction of the contacting position via the at least one locking element. Another embodiment, on the basis of this aspect of the proposed solution for example provides that the interior object is automatically or manually lowered for fixation to the interior surface so that the fixing portion then is present in the intermediate position. In this intermediate position, the at least one locking element is in engagement with the fixing portion so that by transmission of an adjusting force from the at least one locking element to the fixing portion, the fixing portion is displaced (further) in the direction of the contacting position.

With reference to the first aspect explained above, locking with the locking element can also be effected by the further displacement into the contacting position. The adjusting movement in the direction of the contacting position in this variant, however, at the same time is utilized to achieve the electrical connection with the counter-element. For example, the counter-element includes a connector for this purpose.

As an example, a permitted adjustment path of the at least one locking element for the adjustment of the fixing portion from the intermediate position into the contacting position can be greater than a maximally required path in order to additionally tension the interior object against the interior surface via the displacement of the fixing portion. In this way, for example a tolerance compensation can be possible for an interior object with a plurality of fixing elements. This may include the possibility that a locking element is spring-mounted for tolerance compensation and/or the counter-element is spring-mounted.

In one or more embodiments, the at least one locking element is rotatably mounted about a pivot axis extending perpendicularly to the adjustment axis of the fixing element and formed with a curved bracket portion for positively engaging the fixing portion (in order to displace the fixing portion in the direction of the contacting position by transmitting an adjusting force). For example, the at least one locking element in the form of a clamp or pliers can be formed with a corresponding bracket-shaped portion in order to displace a pin-shaped fixing portion into the contacting position and arrest it in the same.

For example, at least two locking elements are provided, which between themselves define a gap for the fixing portion and center the fixing portion for the displacement from the intermediate position into the contacting position. In this way, for example, a connecting operation, for example, a plugging operation for the electrical connection between the fixing portion and the counter-element can be separated from an adjusting movement for the introduction of the fixing portion into the fixing opening. This facilitates for example the design of the plug connection between the fixing portion and the counter-element as well as the control of the connecting operation. For example, by pre-centering via the at least two locking elements a tolerance compensation can be minimized in the plug connection itself.

In principle, at least one adjustment part provided on the interior object can be adjustable when the interior object is fixed to the interior surface. For example, an adjustment part of the interior object is adjustable with respect to the interior surface and/or with respect to a base of the interior object fixed to the interior surface at least or only when the interior object is properly fixed in a fixing position on the interior surface via the at least one fixing element. Consequently, the interior object can no longer be displaced in a non-mechanically guided way along the interior surface and hence along a spatial plane defined thereby for example via its battery-operated drive, when in addition a component of the interior object or an adjustment part arranged thereon shall be adjusted. This for example includes the fact that a vehicle seat as an interior object includes an adjustable adjustment part in the form of a headrest, a seat cushion and/or a backrest, which independently of the battery-operated motorized drive device only is adjustable when the vehicle seat has taken a proper fixing position on the interior surface of the vehicle and has been fixed correspondingly.

An interior object of a proposed vehicle for example, can be a vehicle seat, a (center arm) console or a table. Such an interior object then is freely displaceable e.g. within the vehicle interior—for example, when the vehicle is stationary—and—when the vehicle is traveling—is fixed to the interior surface in a fixing position via the at least one fixing element.

In principle, a proposed fixing device can also be used for a bicycle stand or bicycle rack mounted on a vehicle. The bicycle stand or bicycle rack here is part of a holding device for at least one bicycle, which can be fixed to an interior surface of the vehicle via the fixing device.

In a or more embodiments based thereon, in which the fixing device also provides an electrical connection to a vehicle-side energy source and/or a vehicle-side electronic control system, a holding device connected to the vehicle via the fixing device then provides the possibility to charge an E-bike held on the same. Via the fixing device, an electrically conductive connection to the voltage supply of the vehicle-side on-board network is produced, while the holding device in turn provides an interface for the electrical connection to an electronic system of the E-bike. In this way, a charging function for example can then be integrated into the holding device. Such an integrated charging function or a charger thereby integrated into the holding device for example can also be provided for coupling to another bicycle rack, which for example is fixed via a trailer coupling of the vehicle.

The attached Figures by way of example illustrate possible embodiments of the present disclosure.

### BRIEF DESCRIPTION OF THE DRAWINGS

In the drawings:

FIG. 1 in a sectional top view of an interior surface shows a vehicle interior of a design variant of a proposed vehicle with a plurality of interior objects in the form of vehicle seats freely displaceable therein;

FIGS. 2A to 2C in side views show the interior surface of FIG. 1 with a vehicle seat in two different fixing positions and in different phases during a displacement from a first fixing position to a second fixing position and a subsequent rotation of the vehicle seat;

FIG. 3 in a perspective view shows an exemplary embodiment for an omniwheel for use in the vehicle seat of FIGS. 2A to 2C;

FIG. 4 in a top view shows another design variant of an omniwheel for use in a vehicle seat of FIGS. 2A to 2C;

FIG. 5 schematically and in a top view shows the interior surface of the vehicle of FIG. 1 by illustrating an electronic detection device that includes at least one component on the interior object in the form of the vehicle seat;

FIGS. 6A to 6D on an enlarged scale and each sectionally show a fixing device with a shiftable carriage of a locking unit for locking a fixing element in the form of a fixing bolt provided for the fixation;

FIG. 7A in a perspective view shows a development of the design variant of FIGS. 6A to 6D with a locking unit including the carriage, which is shiftably mounted on guide rails of the fixing device;

FIGS. 7B to 7F in various views show the fixing device of FIG. 7A with the fixing bolt in a position introduced into a fixing opening;

FIG. 8 shows the fixing device of FIGS. 7A to 7F with a sectional representation of an object-side fixing bolt prior to introduction into a fixing opening on the side of the fixing surface, which is still closed by a counter-element of the fixing device;

FIGS. 9A to 9C each in a sectional view show various phases during the introduction of the fixing bolt into the fixing opening and the subsequent locking via the shiftable carriage of the fixing device;

FIGS. 10A to 10D in various views show a design variant of a proposed fixing device comprising a longitudinally shiftable locking unit that includes a coupling area for an electrical connection to a bolt-side coupling area;

FIG. 11 in an individual view shows the fixing bolt of the design variant of FIGS. 10A to 10D including a coupling area;

FIGS. 12A to 12C in various phases sectionally show a design variant in which via vehicle-side locking elements having bracket portions a fixing portion introduced into a fixing opening is displaced in a power-operated way from an intermediate position into a contacting position in which an electrically conductive connection to a vehicle-side counter-element forming a plug connection is produced via the fixing portion;

FIGS. 13 and 14 show possible developments of the design variant of FIGS. 12A to 12C comprising a lever mechanism for the adjustment of a locking element;

FIG. 15 shows a development on the basis of the design variant of FIGS. 12A to 12C comprising a spring-mounted vehicle-side counter-element;

FIG. 16 sectionally shows an alternative adjusting mechanism for the adjustment of a locking element corresponding to the design variant of FIGS. 12A to 15.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As an example, a known vehicle interior, in which interior objects so as to be adjustable on an interior surface in a non-mechanically guided way is described in DE 10 2017 210 608 A1. In this connection, DE 10 2017 210 608 A1 for example proposes to provide for an adjustment of an interior object via an air cushion or via a rolling device. It remains open, however, at what points a proper fixation of such an interior object shall be made possible and how such a fixing position possibly is specified.

From DE 10 2004 046 070 A1 there is furthermore known a fixing device for the fixation of interior objects to a fixing surface defined by a floor plate in a vehicle. Pin-shaped fixing elements in the form of locking pins here engage in holes of the fixing surface and can be locked thereon in order to fix the interior object to the fixing surface. The locking elements are longitudinally shiftably mounted on an interior object and, after positioning of the interior object, can be manually introduced into appropriate holes and be locked thereon in the current position of the interior object. For positioning an interior object in different positions, a plurality of holes are provided as fixing openings for the fixing elements, wherein the holes are arranged in a grid on the floor plate.

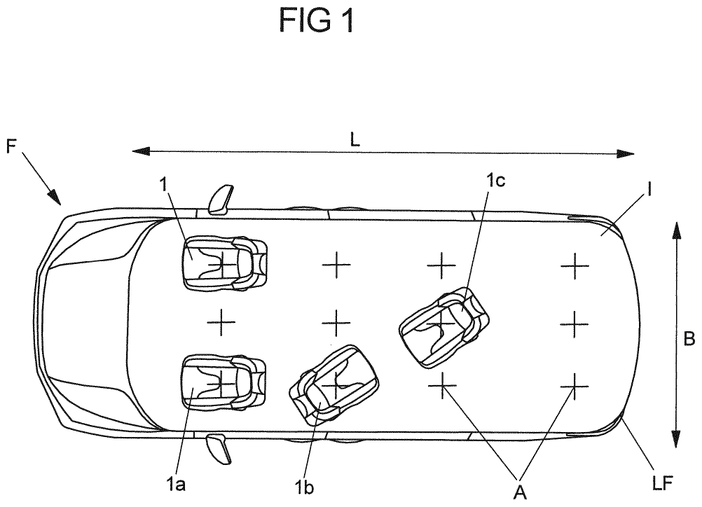

FIG. 1 by way of example shows a vehicle F which in its interior defines a planar interior surface I having a length L and a width B, which extends from a dashboard of the vehicle F to a rear-side loading sill LF. The length L for example lies in the range of 5 to 7.5 m, and the width B lies in the range of 1.5 to 2 m. On the interior surface I a plurality of anchor points A are provided, which serve as fixing positions for fixing different interior objects. The anchor points A here are provided as corner points of a virtual grid distributed on the interior surface I.

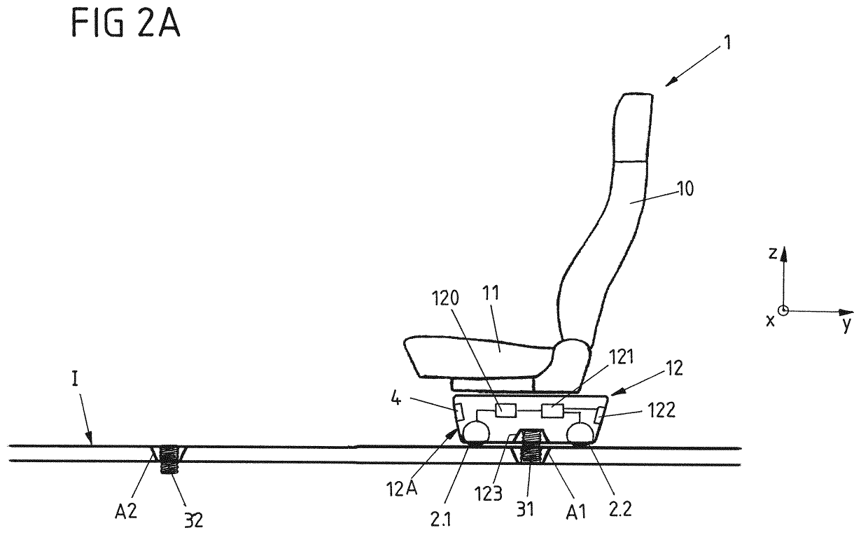

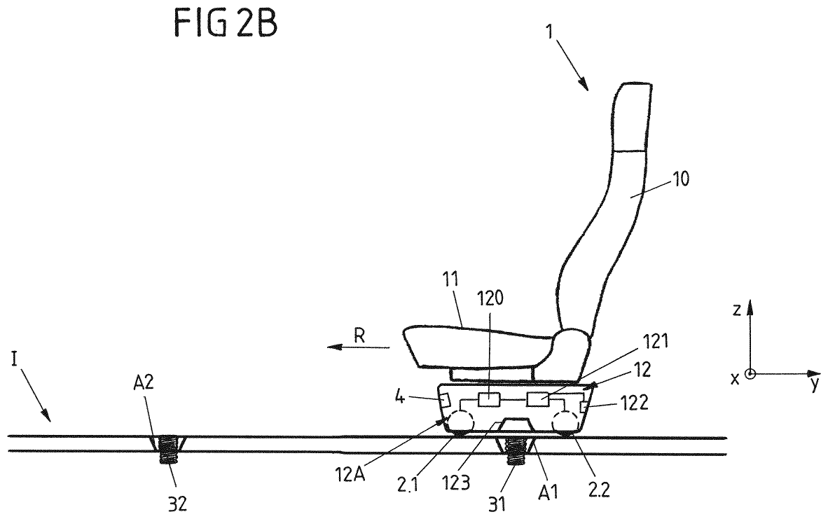

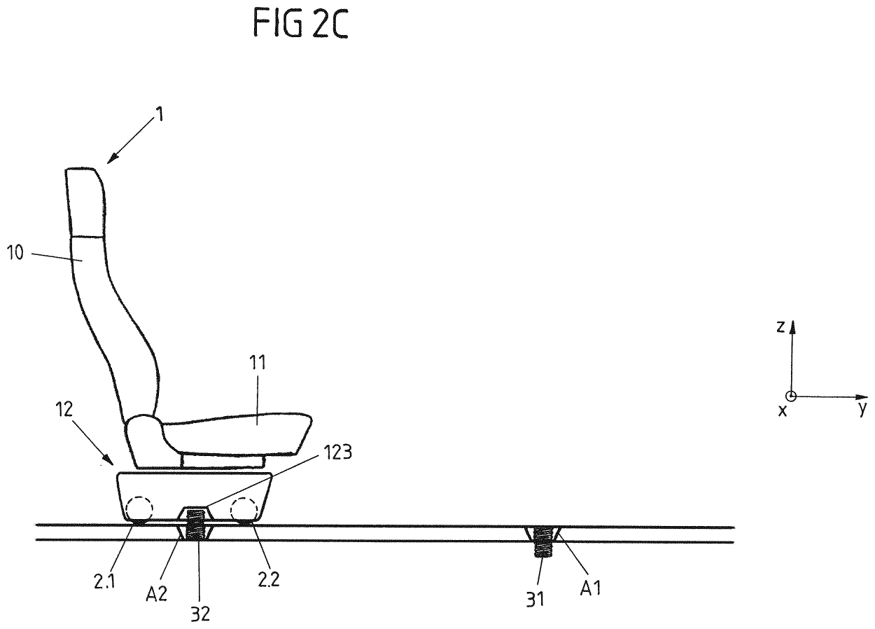

In the present case, for example different vehicle seats 1, 1a to 1c can be fixed at the anchor points A as interior objects. The vehicle seats 1, 1a to 1c here are configured as freely adjustable units that can be displaced on the interior surface I in a non-mechanically guided way, for example, in a non-mechanically track-guided way. When a vehicle seat 1, 1a to 1c is properly arranged at an anchor point A and arranged with a base 12 of the seat 1, 1a to 1c (cf. in particular FIGS. 2A to 2C), the respective vehicle seat 1, 1a to 1c can be fixed to the interior surface I in a crash-proof way. For example, a vehicle seat 1, 1a to 1c in this way can be placed on the interior surface I via a rear loading sill LF (when the liftgate of the vehicle F is open) and can then, in an electronically controlled way, be displaced by a user to a desired anchor point A on the interior surface I and be fixed there. The arrangement of various interior objects like the vehicle seats 1, 1a to 1c thus is extremely variable and can be designed by a user in almost any way.

The side views of FIGS. 2A, 2B and 2C by way of example illustrate a vehicle seat 1 in more detail. The vehicle seat 1 includes a base 12 with a battery-operated motorized drive device 12A. The base 12 displaceable via the motorized drive device 12A carries a seat part 11 and a backrest 10 of the vehicle seat 1. The backrest 10 can be adjustable in its inclination with respect to the seat part 11. Alternatively or additionally, the seat depth can be adjustable via an adjustment of the seat part 11 on the base 12.

The base 12 is freely displaceable on the interior surface I via an omniwheel or a plurality of omniwheels 2.1, 2.2. A torque for displacing the vehicle seat here is applied via a drive motor 120 that is accommodated within the base 12. This drive motor 120 is supplied with power via a battery 121 as an energy accumulator accommodated within the base 12. The battery 121 here can be charged independently of the vehicle via a terminal provided by a connector 122 on the base 12. The vehicle seat 1 thus can be charged on an electric power supply separately from the vehicle F. For this purpose, a vehicle-independent charging station is provided, for example.

When the vehicle seat 1 is provided at one of the anchor points A1, A2 shown in FIGS. 2A, 2B and 2C, the vehicle seat 1 can be fixed via a vehicle-side fixing element in the form of a fixing bolt 31. The fixing bolt 31, which is part of a fixing device 3, therefor is turned upwards into a coupling portion 123 of the base 12 at the anchor point A1, which coupling portion defines a fixing opening for the fixing bolt 31, 32. In addition to the fixing bolt 31 shown by way of example, further fixing elements and for example, fixing bolts 31 can be provided in order to fix the base 12 and hence the vehicle seat 1 at the anchor point A1 of the interior surface I in a crash-proof way.

Via the fixing bolt 31 engaging in the base 12 and hence present in a fixing position, a connection to a vehicle-side energy source, hence to a vehicle-side battery, can also be provided in the present case. Via the electrical connection, for example the battery 121 then can be charged (for example, when the vehicle is traveling).

Alternatively or additionally, via the coupling to the electric energy supply of the vehicle F at least one additional electromotive drive of the vehicle seat 1 can be supplied with power in order to for example adjust the backrest 10 or the seat part 11 in a power-operated way. For example, the seat part 11 on the base 12 can be rotatable in a power-operated way about a vertical axis extending parallel to a spatial direction z by more than 90°, for example, by up to 180° or even by 360°, at least when the base 12 is properly fixed at an anchor point A1 (or A2; cf. FIG. 2C).

In response to a user request for operation, the vehicle seat 1 can be displaced along the interior surface I from the anchor point A1 to another anchor point A2. For this purpose, the fixing bolt 31 initially is retracted into a starting position on the interior surface I and the base 12 thereby is released. The vehicle seat 1 then can motorically be displaced along a direction of displacement R from the anchor point A1 to the anchor point A2 by means of the omniwheels 2.1, 2.2. This power-operated displacement of the vehicle seat 1 is controlled via an electronic detection device D, which in the present case includes a detection element 4 provided on the base 12. For example, this is a tag 4 which in cooperation with at least one vehicle-side sensor element of the detection device D provides for an electronic detection of the position of the seat 1 on the interior surface I.

In this way, it is possible for example to electronically detect when the vehicle seat 1 has reached the (second) anchor point A2, namely in such a way that a vehicle-side fixing bolt 32 can engage in the coupling portion 123 of the base 12 at this (second) anchor point A2 in order to fix the vehicle seat 1 at the anchor point A2. Thereafter, the vehicle seat 1 for example can be rotated about the vertical axis by 180°.

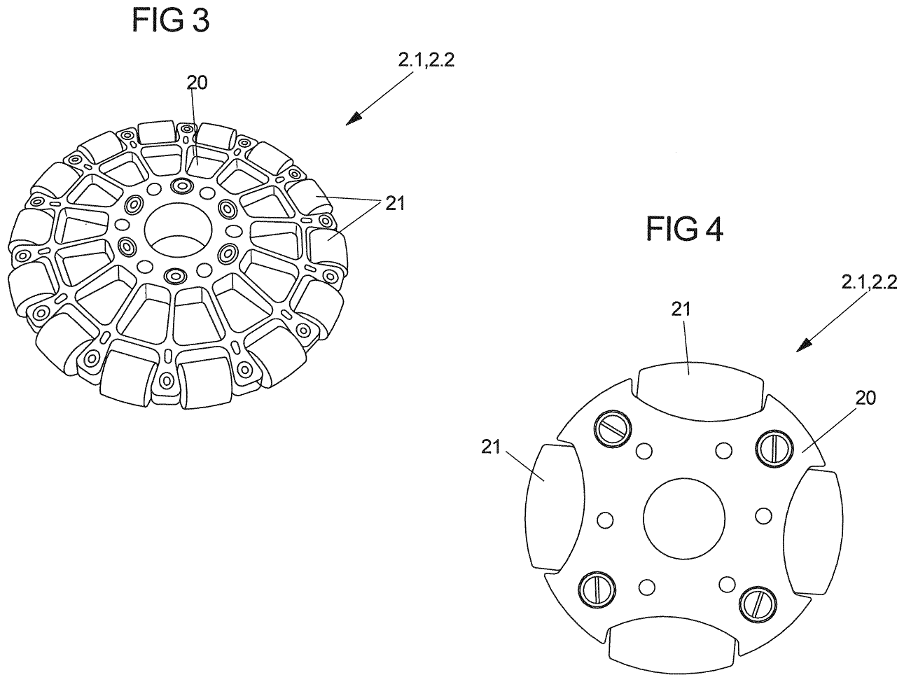

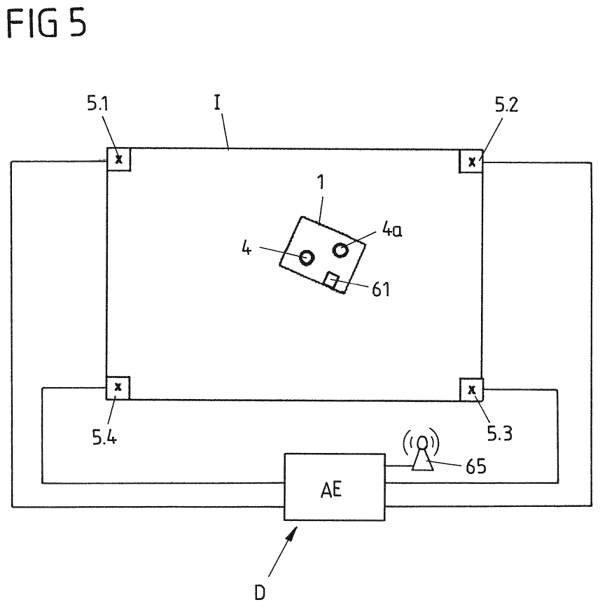

FIGS. 3 and 4 by way of example illustrate possible design variants for an omniwheel 2.1, 2.2 on the base 12 of the vehicle seat 1. FIG. 3 for example shows a perspective view of an omniwheel 2.1, 2.2 with a disk-shaped roller support 20 on whose circumference a plurality of rollers 21 are rotatably mounted. In the design variant of an omniwheel 2.1, 2.2 of FIG. 4, merely four rollers 21 each are rotatably arranged on a disk-shaped roller support 20 offset from each other by 90° each around a center of the roller support 20. Via each of the roller supports of FIGS. 3 and 4 an adjustment is possible in each spatial direction along a plane.

FIG. 5 in a top view by way of example illustrates a possible design of a detection device D, via which the position of a vehicle seat 1 can be detected during a displacement on the interior surface I. In the illustrated design variant, four sensor elements 5.1-5.4 are provided at defined positions of the vehicle interior and possibly on the interior surface I of the vehicle F (e.g. at its corner points).

The vehicle seat 1 furthermore includes a tag 4 and possibly an additional tag 4a. The tags 4, 4a here can be detected via the sensor elements 5.1-5.4, for example by the tags 4, 4a actively emitting signals that can be received by the sensor elements 5.1-5.4, or by the sensor elements 5.1-5.4 being read out in the manner of an RFID label. In this way, a position of the vehicle seat 1 within a spatial detection field on the interior surface I defined or monitored by the sensor elements 5.1-5.4 can be detected by means of the detection device D. Via an electronic evaluation unit AE of the detection device D coupled to the sensor elements 5.1-5.4, a position of the vehicle seat 1 on the interior surface I then can be determined from generated sensor signals, e.g. by means of triangulation.

To improve the detection of a position of the vehicle seat 1 and avoid wrong detections, different measurement principles for example are combined with each other so that the position of the vehicle seat 1 on the interior surface I is monitored via sensor elements 5.1-5.4 utilizing different measurement principles. For example, a Lidar system, a radio-based tracking, based for example on electromagnetic waves, such as radar waves, UWB, Bluetooth, a searching wire in the floor or on the ceiling, a detection on the basis of infrared signals and/or ultrasonic signals can be provided.

In the design variant of FIG. 5, the detection device D additionally includes a transmitter unit 65 which with reference to the position of the vehicle seat 1 on the interior surface I determined by the electronic evaluation unit AE sends control signals to the motorized drive device 12 of the vehicle seat 1. Here, the vehicle seat 1, for example likewise on the base 12, includes a receiver unit 61 that is adapted to receive the control signals of the transmitter unit 65. The receiver unit 61 is coupled to the drive motor 120 of the base 12 in order to displace the vehicle seat 1 corresponding to the control signals 65 and hence for example, in dependence on the detected position of the vehicle seat 1 on the interior surface Ito a desired anchor point A, A1 or A2.

The displacement of the vehicle seat 1 here can be controllable for example by a user by means of a control application, for example, a control application installed on a mobile phone. Alternatively or additionally, a particular position of a vehicle seat 1 on the interior surface I can be preconfigured, possibly also in combination with specified positions for further interior objects, such as for example a center arm console or a table. In this way, a user for example can select a particular preconfiguration and cause the vehicle seat 1—and possibly further interior objects—to be automatically moved into position via the detection device D. A corresponding control for the displacement of a vehicle seat 1 (or further interior objects) on the interior surface I alternatively or additionally can be integrated into the vehicle F. This may include the setting and future execution of one or more preconfigurations on a vehicle-side operating unit for the arrangement of one or more interior objects.

In an exemplary method for displacing a vehicle seat 1 by means of the detection device D, the same for example is initially switched on. This can be followed by the fact that the sensor elements 5.1-5.4 initially are synchronized and checked for operability. Then, one of the tags 4, 4a, for example a first tag 4, is queried by means of one of the sensor elements 5.1. This first tag 4 sends a response signal that is received by all sensor elements 5.1-5.4. Via the electronic evaluation unit AE, the runtime differences then are evaluated, which result from querying the tag 4 and from the (response) signal of the tag 4 received in response thereto at the individual sensor elements 5.1-5.4. Then, a position value representative of the position of the tag 4 and hence of the vehicle seat 1 can be calculated therefrom.

Via an analogous procedure for the further tag 4a a further position value is obtained for the vehicle seat 1. This further position value can be used for a (plausibility) check of the position value determined by means of the first tag 4 and/or for a determination of an orientation of the vehicle seat 1 with respect to the sensor elements 5.1-5.4 on the interior surface I. With reference to the position of two tags 4, 4a, which are arranged on the vehicle seat 1 in a particular, fixed position relative to each other, it can not only be determined at what point the vehicle seat 1 is located, but also how the vehicle seat 1 or its base 12 is oriented on the interior surface I. On the basis of the determined position(s) of the vehicle seat 1 the displacement of the vehicle seat 1 then is effected, until the same has reached a desired fixing position at which the vehicle seat 1 is fixed and hence can be secured in its reached fixing position at an anchor point A, A1 or A2.

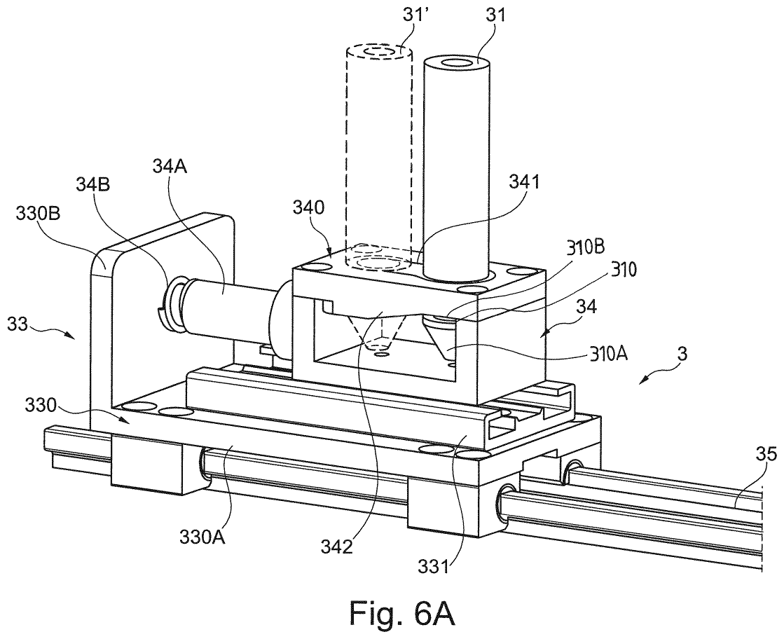

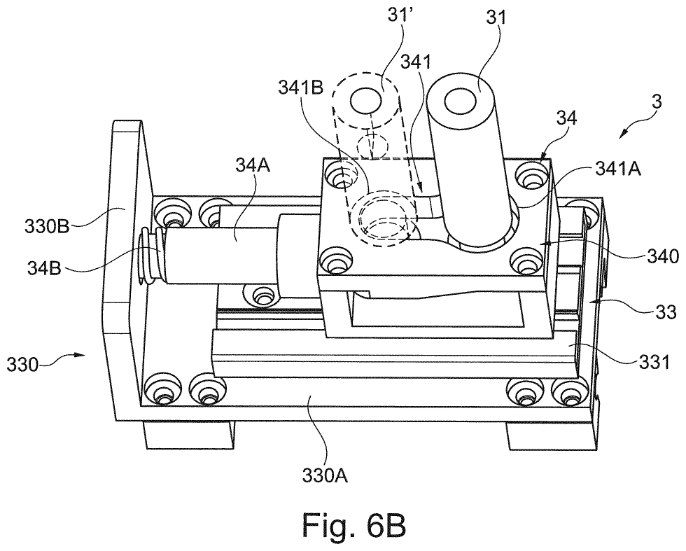

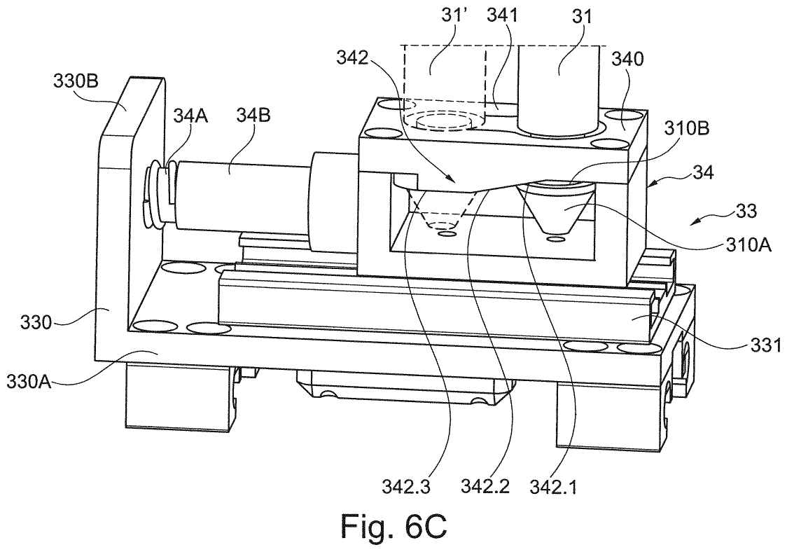

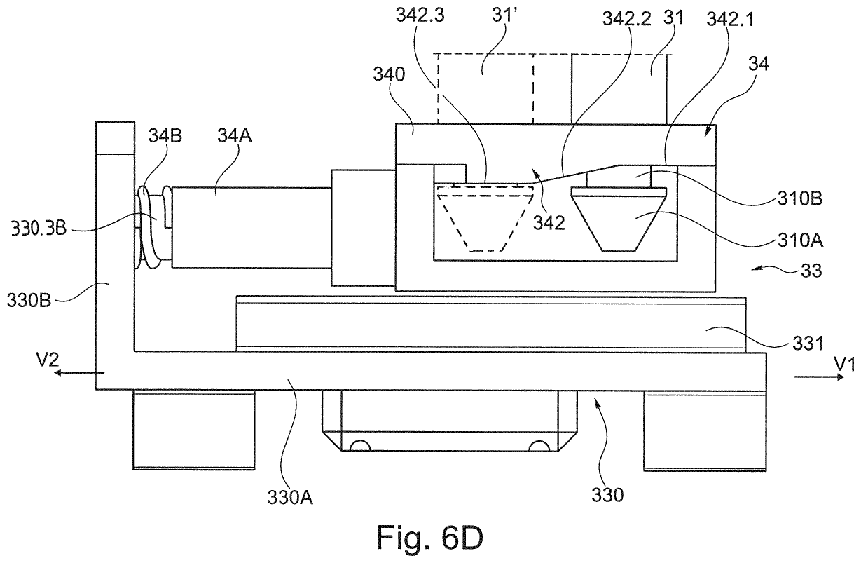

FIGS. 6A to 6D sectionally show further details of a fixing device 3, as it can be used for example, for a vehicle seat 1 of FIGS. 2A to 2C. In principle, however, a design variant of a proposed fixing device 3 can also be employed in other objects, for example, in objects that are manually transferred into a desired fixing position, i.e. for example are put down by a user at a fixing position.

FIGS. 6A to 6D in different views illustrate a power-operated fixation by means of a shiftable locking unit 33 of the fixing device 3.

In the design variant shown in FIGS. 6A, 6B, 6C and 6D a fixing bolt 31 each is rigidly formed to protrude from an underside of the vehicle seat 1. For introducing the fixing bolt 31 into a fixing opening on the interior surface I, the vehicle seat 1 or at least a component of the vehicle seat 1 carrying the fixing bolt 31, such as the base 12, consequently has to be lowered to such an extent that a fixing portion 310 of the fixing bolt 31 can dip into the fixing opening. This can be achieved for example via lowerable wheels of the vehicle seat 1.

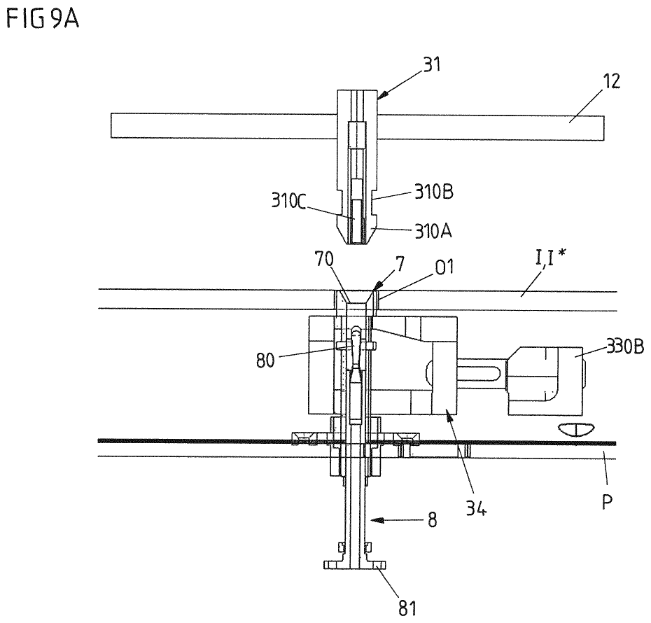

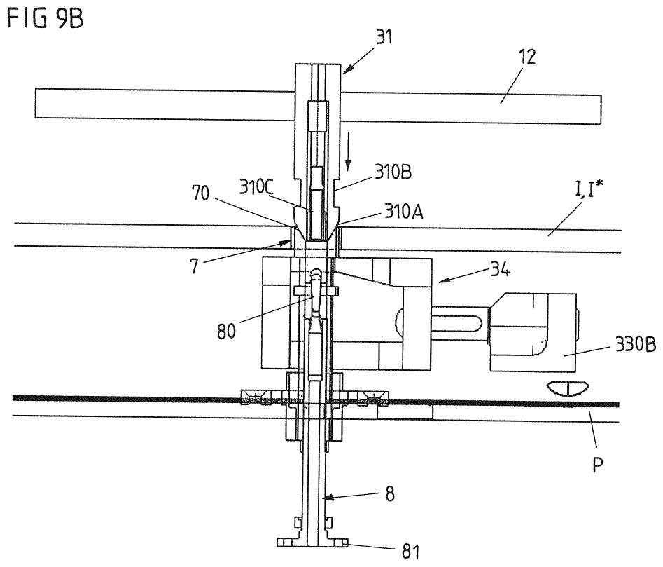

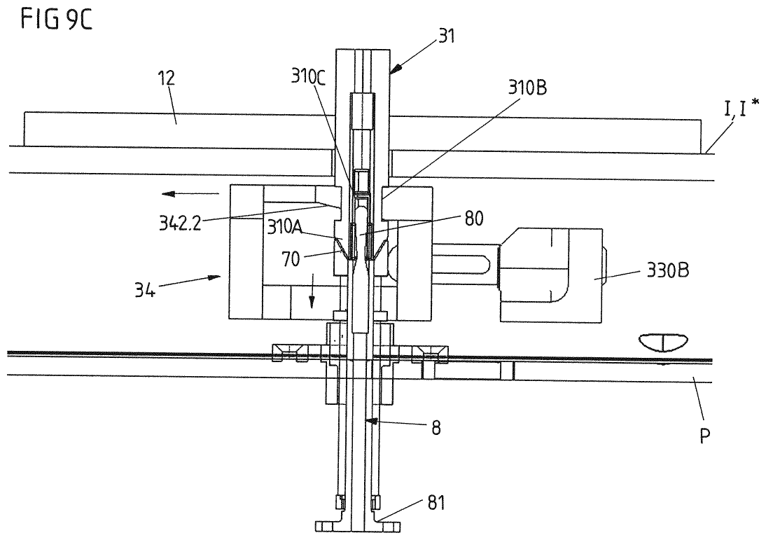

The fixing portion 310 of the fixing bolt 31 here protrudes from a through opening on the vehicle seat 1, at whose end an introduction cone 310A is formed for easier introduction into a fixing opening O1 (cf. FIG. 9A) on the fixing surface, here the interior surface I.

For fixing the fixing bolt 31 to the interior surface I, a shiftable locking unit 33 in the present case is provided as part of the fixing device 3. Below the interior surface I, the locking unit 33 is shiftably mounted via at least one guide rail 35 along mutually opposite adjustment directions V1 and V2. The adjustment directions V1 and V2 each extend transversely to an adjustment axis, along which the fixing bolt 31 can be introduced into a respective fixing opening O1 on the interior surface I.

The locking unit 33 is shiftably held on the guide rail 35 via a base 330. On this base 330, a sliding carriage 34 in turn is longitudinally shiftably mounted. For the longitudinal shiftability of the carriage 34 on the base 330 a carriage guide 331 is provided on the base 330. This carriage guide 331 is carried by a guide part 330A of the base 330, via which the base 330 is shiftably held on the guide rail 35. From the base 330 hence L-shaped in cross-section, the support part 330B protrudes substantially perpendicularly to this guide part 330A.

Via a spring element in the form of a compression spring 34B, the carriage 34 is elastically pretensioned in the adjustment direction V1 against a base-side support part 330B. For this purpose, the compression spring 34B on the one hand is supported on the support part 330B and on the other hand on a carriage-side support sleeve 34A. In this way, the carriage 34 with the base 330 can be shifted along the adjustment directions V1 and V2. At the same time, the carriage 34 itself can additionally be displaced on the base 330 and is elastically pretensioned in the adjustment direction V1. At the support part 330B, the compression spring 34B is put onto a bearing pin 330.3B protruding therefrom.

The locking unit 33 and hence for example, the carriage 34 is shifted into the adjustment direction V1 when the fixing bolt 31 has been properly introduced into a fixing opening O1 associated to the carriage 34 and correspondingly the fixing bolt 31 and hence the respective object, here for example the vehicle seat 1, shall be fixed to the interior surface I. The carriage 34 therefor includes a locking plate 340 with a locking opening 341 facing the underside of the interior surface I. The locking opening 341 of the carriage-side locking plate 340 is arranged below the fixing opening O1 on the side of the interior surface, namely initially in a release position in which a first opening portion 341A of the locking opening 341 is brought into coincidence with the fixing opening O1. At this first opening portion 341A, the locking opening 341 has sufficiently large dimensions so that the fixing bolt 31 with its fixing portion 310 including the introduction cone 310A can engage through the fixing opening O1 into the locking opening 341 of the carriage 34. At the fixing portion of the fixing bolt 31 an engagement area in the form of an annular groove 310B is formed, in the present case adjacent to the introduction cone 310A.

When the carriage 34 is in its release position below the fixing opening O1, the fixing bolt 31 can reach through the locking opening 341 at the first opening portion 341A to such an extent that the annular groove 310B protrudes below a release area 342.1 of a clamping portion 342 of the carriage 34, which is formed on two long sides of the locking plate 340. When the carriage 34, subsequent to the introduction of the fixing bolt 31 into the fixing opening O1 and hence into the locking opening 341 of the carriage 34, is shifted in the adjustment direction V1 transversely to the direction of introduction of the fixing bolt 31, a second opening portion 341B of the locking opening 341 gets in engagement with the fixing bolt 31 at its annular groove 310B. The second opening portion 341B has distinctly smaller dimensions so that a shoulder of the annular groove 310B adjoining in the direction of the introduction cone 310A prevents the fixing bolt 31 from being withdrawn from the locking opening 341. In the present case, the locking opening 341 with its opening portions 341A, 341B has a keyhole-shaped contour in a top view. In the locking position of the carriage 34 taken due to the displacement in the adjustment direction V1, the carriage 34 as a locking element of the fixing device 3 consequently is positively locked to the fixing bolt 31 at the fixing opening O1 and blocks the same against being withdrawn from the locking opening 341.

To furthermore tension the fixing bolt 31 and hence the object carrying the fixing bolt 31 against the interior surface I by displacing the carriage 34 into its locking position, the clamping portion 342 of the carriage 34 forms a ramp area 342.2 adjacent to the release area 342.1 in the adjustment direction V2. This ramp area 342.2 extends with an inclination to the adjustment axis of the fixing bolt 31 and hence with an inclination to the original direction of introduction of the fixing bolt 31. On displacement of the carriage 34 along the adjustment direction V1, the carriage 34 with its locking plate 340 slides over the ramp area 342.2 along the shoulder of the annular groove 310B and—as a result of the inclination of the ramp area 342.2—thereby urges the fixing bolt 31 further in the original direction of introduction (e.g. downwards in the representation of FIG. 6D). When the carriage 34 is in its locking position in which a pretensioning force is applied to the same via the compression spring 34B, the fixing bolt 31 consequently has been displaced into a tensioning position via the ramp area 342.2 of the clamping portion 342 and is arrested in such a tensioning position, in which a shoulder of the annular groove 310B engages behind the clamping portion 342 at a clamping area 342.3 adjoining the ramp area 342.2 in the adjustment direction V2. The ramp area 342.2 of the clamping portion 342 at the carriage 34 thus ensures an arrestment of the fixing bolt 31 under tension at the carriage 34. The compression spring 34B, which pretensions the carriage 34 in the adjustment direction V1, supports the taking of the locking position by the carriage 34.

To release the locking of the fixing bolt 31 at the locking unit 33 and again unlock the fixing bolt 31, so that the vehicle seat 1 can again be displaced on the interior surface I, the locking unit 33 and hence the carriage 34 is moved back in the adjustment direction V along the guide rail 35. Then, the fixing bolt 31 no longer is in the position 31′ shown in dashed lines in FIGS. 6A to 6D, but again is in the area of the first opening portion 341A (of larger dimension) of the locking opening 341. In this way, the fixing bolt 31 can again be withdrawn from the locking unit 33 and hence from the fixing opening O1 on the side of the interior surface.

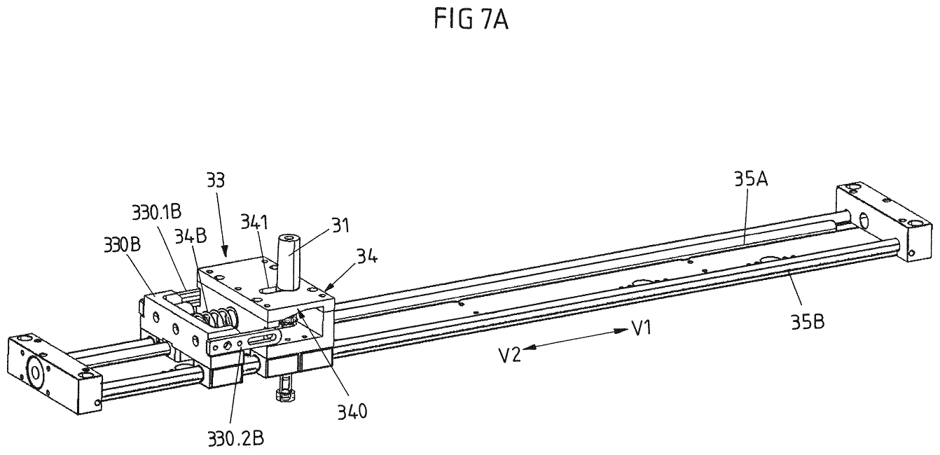

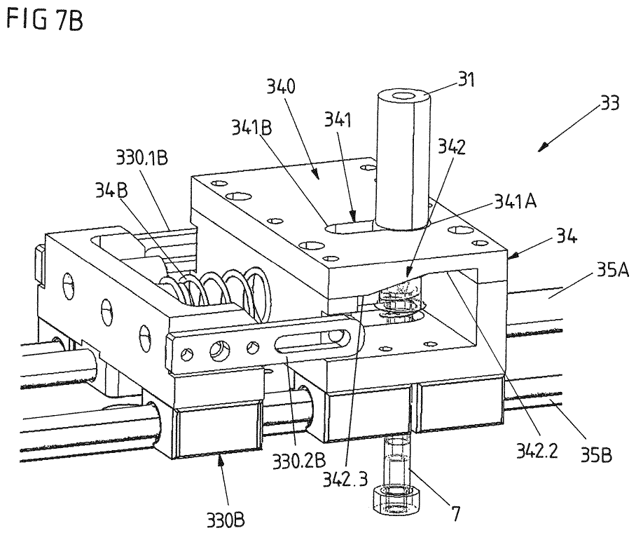

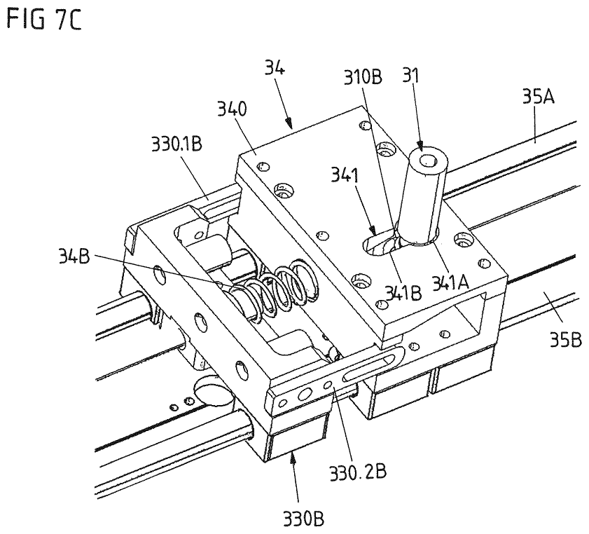

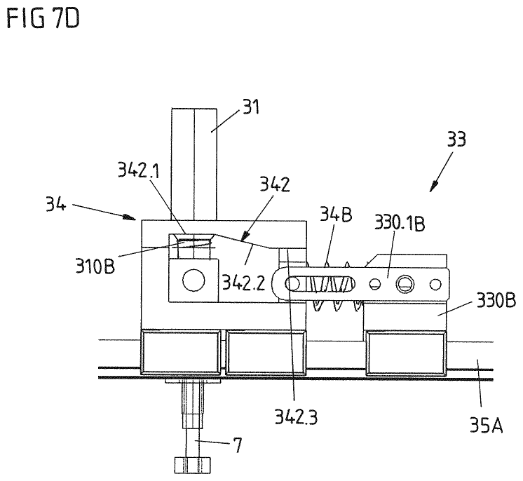

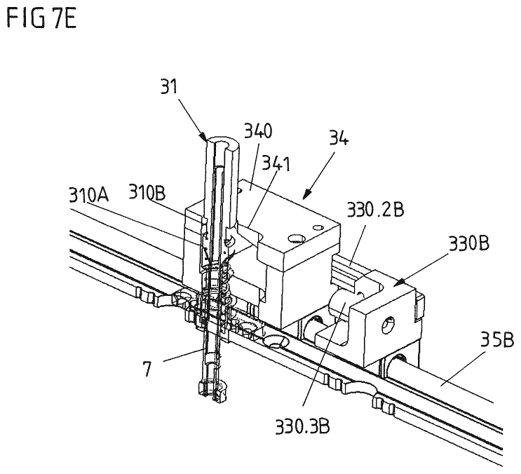

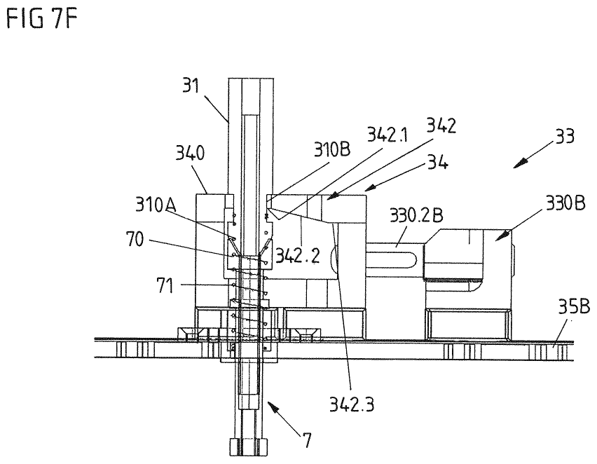

In the development of a fixing device 3 with a shiftably mounted locking unit 33, which is shown in FIGS. 7A to 7F, 8 and 9A to 9C, elements corresponding with the design variant of FIGS. 6A to 6D are designated with identical reference numerals.

As is illustrated for example in the perspective view of FIG. 7A, the locking unit 33 of this development here is shiftably mounted on two guide rails 35A and 35B extending parallel to each other along the adjustment directions V1 and V2. Instead of a base jointly carrying the carriage 34 and the support part 330B, the carriage 34 and the support part 330B here are shiftably held directly on the guide rails 35A and 35B as separate components of the locking unit 33. To again pressurize the carriage 34 via the compression spring 34B in the adjustment direction V1, the compression spring 34B on the one hand is supported on the carriage 34 and on the other hand on the support part 330B. A driving force applied by a motor for shifting the locking unit 33 here is applied onto the support part 330B, relative to which the carriage 34 is longitudinally shiftably mounted.

To limit the displaceability of the carriage 34 and of the support part 330B relative to each other along the guide rails 35A, 35B, there are provided two connecting arms 330.1B and 330.2B extending parallel to each other. These connecting arms 330.1B and 330.2B are fixed to the support part 330B and each engage the carriage 34 via an oblong hole connection. Via this oblong hole connection, a limited displaceability of the carriage 34 relative to the support part 330B is given and it is ensured that the carriage 34 not only is displaced along with a displacement of the support part 330, but remains additionally pretensioned with respect to the support part 330B via the compression spring 34B also during an adjustment in the adjustment direction V1.

As can be taken in particular from the perspective representations of FIGS. 7B and 7C, the locking unit 33 of FIGS. 7A to 9C also includes a locking plate 340 with a keyhole-shaped locking opening 341 and a clamping portion 342 with an inclined ramp area 342.2, in order to ensure locking of the fixing bolt 31 at the locking unit 33 via a displacement of the carriage 34 in the adjustment direction V1.

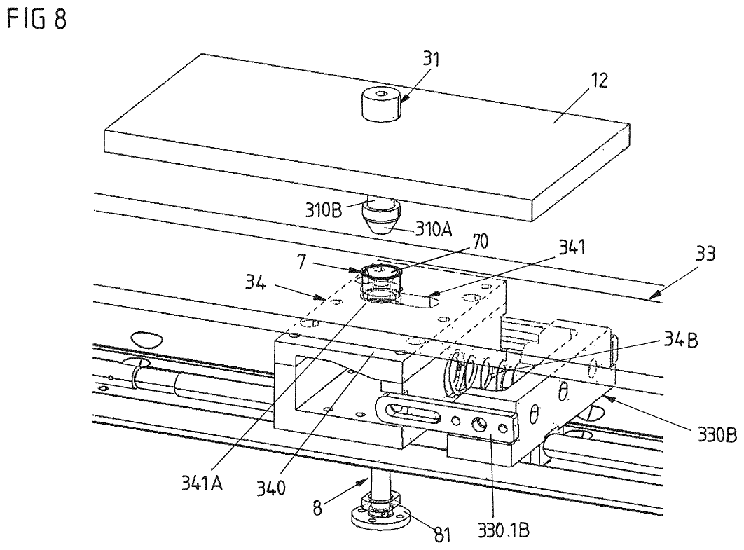

As can be taken from the sectional and partly sectional representations of FIGS. 7D, 7E and 7F, the fixing device 3 here additionally includes an adjustably mounted counter-element 7. This counter-element 7, which here is pin-shaped, protrudes through the locking unit 33 and is pretensioned in the direction of the fixing opening O1 via a compression spring 71. Against the action of the compression spring 71, the counter-element 7 is displaced on introduction of the fixing bolt 31. As is illustrated in the perspective detail representation of FIG. 8 and in the sectional representation of FIGS. 9A, 9B and 9C, the counter-element 8 here is pretensioned via the compression spring 71 into a closed position in which the counter-element 7 closes the fixing opening O1 on the interior surface I by means of a closure portion 70, when no fixing bolt 31 is inserted into said fixing opening. When an object, such as for example the vehicle seat 1, is to be fixed to the fixing opening O1, the fixing bolt 31 displaces the counter-element 7 against the action of the compression spring 71 so that the fixing bolt 31, as explained above, can reach through the fixing opening O1 and engage in the locking opening 341 of the carriage 34. To facilitate the displacement of the counter-element 7, the closure portion 70 of the counter-element 7 includes a conical receptacle as a counter-contour to the introduction cone 310A of the fixing bolt 31, in which the introduction cone 310A can be inserted.

As is illustrated for example, in FIGS. 8 and 9A to 9C, the counter-element 8 in the illustrated design variant is longitudinally shiftably mounted (namely along the adjustment axis of the fixing bolt 31) on a holder in the form of a plug pin 8. This immovably fixed plug pin 8 is fixed via an arrestment base 81, for example on the body side, so that the carriage 34 is adjustable relative thereto. The plug pin 8 extends through a base plate P present between the guide rails 35A and 35B. In the present case, for example, the counter-element 7 enclosing the plug pin 8 in a sleeve-shaped manner can at least partly be shiftable through a through opening on this base plate P in order to switch between its closing position and an adjustment position displaced by the fixing bolt 31.

The plug pin 8 furthermore carries a contact element in the form of a contact head 80, relative to which the counter-element 7 is shiftable. The contact head 80 therefor is centrally received in a sleeve-shaped portion of the counter-element 7.

The contact head 80 is accessible within the carriage 34 by displacing the counter-element 7, when the fixing bolt 31 has been sufficiently introduced into the fixing opening O1 (by displacing the counter-element 7). When the fixing bolt 31 is in its tensioning position after the longitudinal displacement of the carriage 34 in the adjustment direction V1 (and the carriage 34 hence is in its locking position), the contact head 80 protrudes from the closure portion 70 of the counter-element 7 and protrudes into the fixing bolt 31 through an opening formed on the introduction cone 310A. In the interior of the fixing bolt 31 a contact/plug sleeve 310 is provided, with which the contact head 80 plugged in produces an electrical connection when the fixing bolt 31 has been properly locked in place on the carriage 31 corresponding to FIG. 9C. In this way, by locking the fixing bolt 31 at the locking unit 33 an electrical connection between the object to be fixed and a vehicle-side voltage source and/or superordinate electronic control unit can also be provided, namely especially via the fixing element utilized for fixation, here in the form of the fixing bolt 31.

Via the illustrated fixing device 3, the fixation of another object—e.g. in the form of a battery carrier—to a fixing surface I* can also be effected. For example, a fixation of the battery carrier to an underside of a vehicle floor as a fixing surface is possible. On the battery carrier a plurality of battery cells for an electric vehicle, such as an electric car, can be arranged. Via a fixing device 3 comprising a locking unit 33 and at least one fixing element 31 (of correspondingly stable design) or a plurality of fixing elements 31 such a battery carrier carrying a plurality of battery cells thus can be easily fixed to a vehicle floor in an electronically controlled and power-operated way.

In principle, a plurality of locking units 33 with a plurality of fixing elements can also be provided for fixing an individual object at a fixing position on the object side or vehicle side.

Furthermore, alternatively or additionally the locking carriage 34 (alone) can be utilized for producing an electrical connection instead of the contacting between the fixing bolt 31 and the vehicle-side counter-element 7 illustrated for example, with FIGS. 9A to 9C. The locking carriage 34 for example can include an electrically conductive coupling area which upon adjustment of the locking carriage 34 into its locking position is brought in contact with a corresponding coupling area on the fixing portion 310 of the fixing bolt 31. Correspondingly, an electrical connection here is not realized via the (here vertical) adjusting movement of the fixing bolt 31, but via a perpendicularly extending (typically horizontal) adjusting movement of the locking means 34.

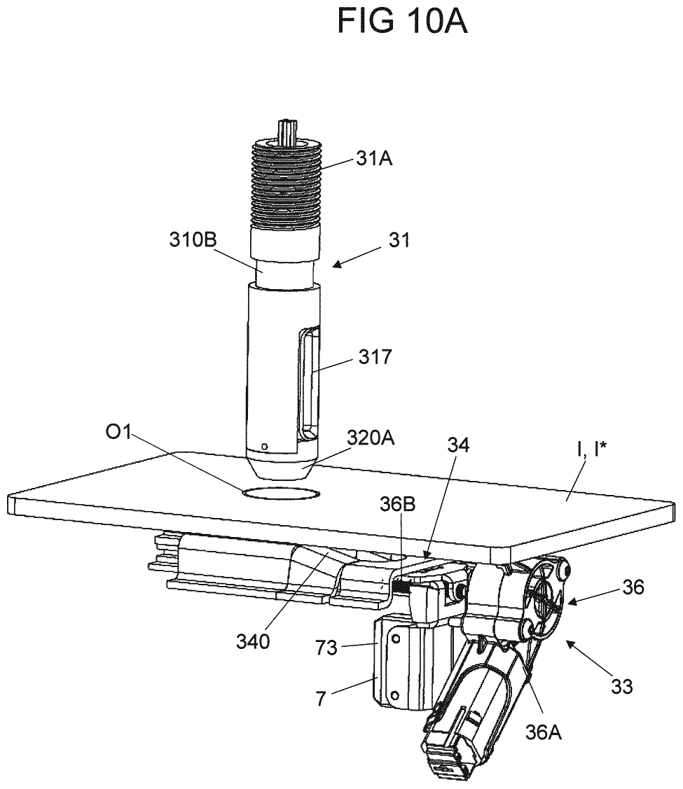

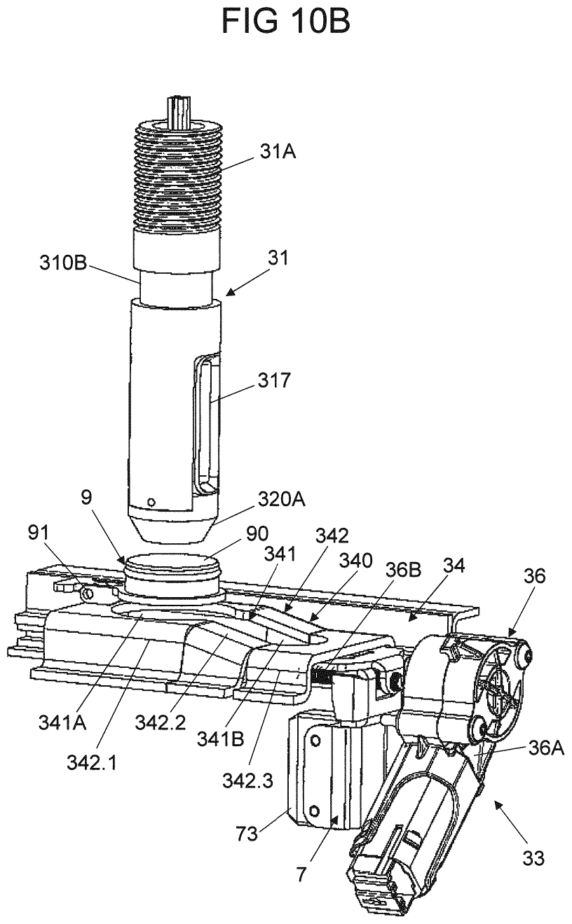

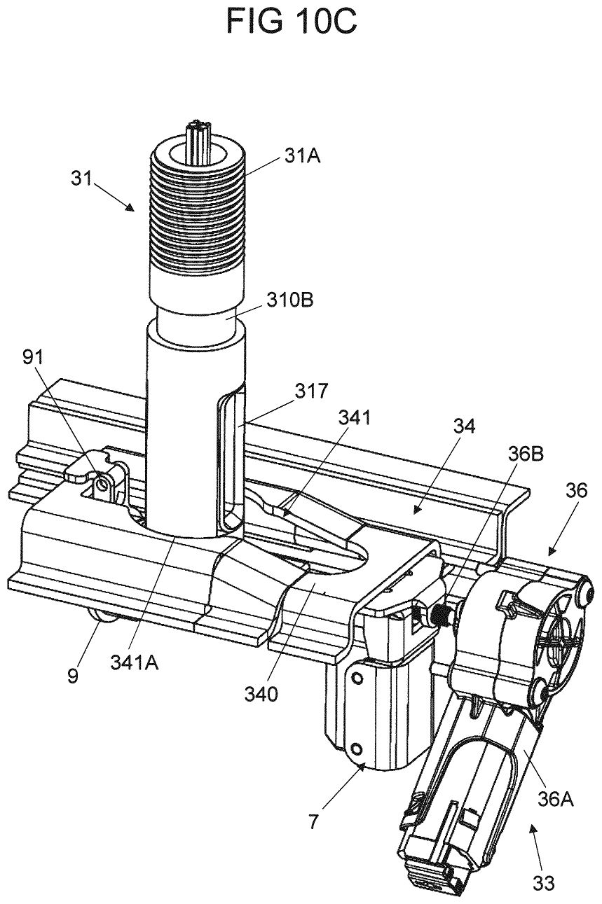

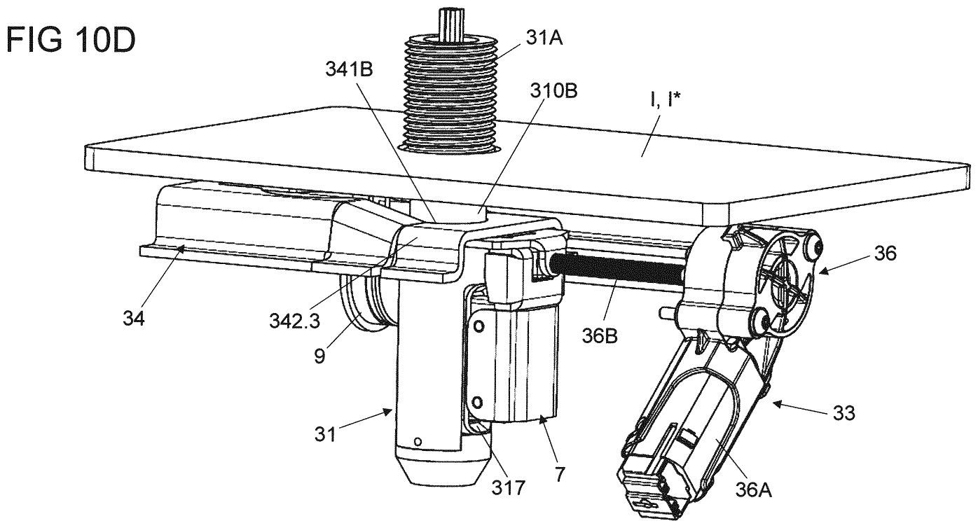

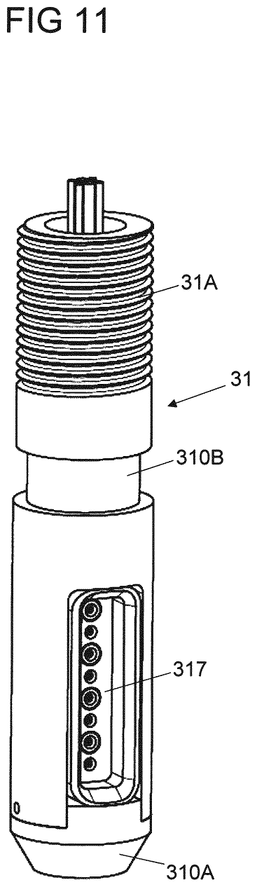

FIGS. 10A to 10D and 11 show a design variant of a proposed fixing device in which an electrical connection between a coupling area 317 of a fixing bolt 31 and a carriage-side coupling area 73 is realized via an adjusting movement of the locking carriage 34, which extends perpendicularly to an adjusting movement of the fixing bolt 31.

For this purpose, a counter-element 7 is fixed to the locking carriage 34 carrying the locking plate 340 with the locking opening 341, which includes the coupling area 73. The coupling area 73 for example is configured as a connector. When the fixing bolt of the design variant of FIGS. 10A to 10D, which in FIG. 11 is shown in an individual view, is introduced into the through opening O1 to such an extent that the locking carriage 34 can clampingly engage in the annular groove 310B of the fixing bolt 31 via the locking opening 341, the bolt-side coupling area 317 is present below the locking plate 340 and disposed opposite the carriage-side coupling area 73. By a translational adjustment of the locking carriage 34, the carriage-side coupling area 73 then can be plugged to the bolt-side coupling area 371, when the fixing bolt 31 is locked on the locking carriage 34.

For the translational adjustment of the locking carriage 34, the locking unit 33 of the design variant of FIGS. 10A to 10D includes an electromotive drive 36. The drive 36 may include an electric motor unit 36A via which a (drive) spindle 36B can be driven. A spindle nut of the locking carriage 34 meshes with the spindle 36B so that due to the electromotively driven rotation of the spindle 36B the locking carriage 34 can be translationally adjusted along the spindle axis. Due to this adjustment, the locking plate 340 can lock or unlock the fixing bolt 31.

In the design variant shown in FIGS. 10A to 10D and 11, the fixing bolt 31 has a drive portion 31A above the annular groove 310B (and hence at the end opposite to the introduction cone 310A). At this drive portion 31A, a drive movement is introduced into the fixing bolt 31 in order to introduce the same into the through opening O1 or withdraw the same from the through opening O1. For example, the drive portion 31A therefor includes an external thread.

In the design variant of FIGS. 10A to 10D and 11, it is furthermore provided that the through opening O1 is closed on the fixing surface I, I*—when the fixing bolt 31 is not introduced—by a separate closure element 9. This closure element 9 is pivotally mounted about a pivot axis 91 between a closed position and an open position, in the present case on the locking carriage alternatively e.g. on an underside of the fixing surface I, I*. In the closed position, the closure element 9 protrudes into the through opening O1 with a closure portion 90 and closes said opening completely. By introducing the fixing bolt 31 into the through opening O1, the closure portion 90 elastically pretensioned into the closed position, for example via a spring element, is displaced in the direction of the open position.

In the design variant of FIGS. 10A to 10D and 11 the closure portion 90 for example is pivotable about the pivot axis 91 by more than 70°, for example, by 90°, from the closed position into the open position. The closure portion 90 is held in the open position via the properly introduced fixing bolt 31 so that only by withdrawing the fixing bolt 31 from the through opening O1 is the closure portion 90 again moved back into the closed position and closes the through opening O1. The closure element 9 here is fixed to the locking carriage 34 and hence firmly mounted to the carriage. In the present case, the guide element 9 is provided at the edge in the region of the opening portion 341A of the locking opening 341, e.g. attached to the locking plate 340. Furthermore, the closure portion 90 of the closure element 9 is dimensioned such that during a swivel movement from its closed position into the open position the closure portion 90 can be displaced through the locking opening 341 in the locking plate 340.

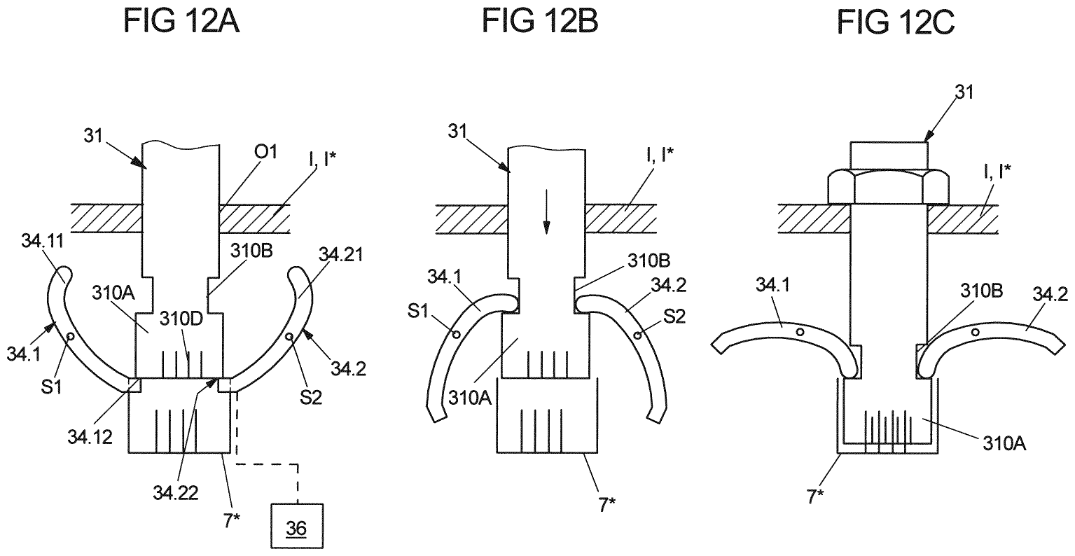

FIGS. 12A-12C and 13 to 16 illustrate further design variants of the present disclosure, in which a fixing bolt 31 introduced into the fixing opening O1 is blocked against removal from the fixing opening O1 via at least one additional locking element 34.1, 34.2, and in addition an electrical connection to a vehicle-side energy source and/or a vehicle-side electronic control unit, and hence to the on-board network of the vehicle F, is produced via the fixing bolt 31.

In the design variant of FIGS. 12A to 12C, two locking elements 34.1 and 34.2 are provided below the interior surface I, I*, which between themselves define a gap for the fixing portion 310 of the fixing bolt 31 to be introduced. In the present case, each locking element 34.1 and 34.2 is rotatably mounted about a pivot axis S1 or S2 and forms a curved bracket portion 34.11 or 34.21. The two locking elements 34.1 and 34.2 jointly form a clamp or plier unit, which with the fixing bolt 31 introduced between its locking elements 34.1, 34.2 engage into the annular groove 310B and thereby subsequently arrest the fixing bolt 31 in its fixing position.

The locking elements 34.1 and 34.2 are configured and arranged in such a way that the introduction cone 310A of the fixing bolt 31 below the interior surface I, I* initially abuts against stops 34.12 and 34.22 of the locking elements 34.1 and 34.2 and thereby pivots the locking elements 34.1 and 34.2 from a zero position into an engagement position in which the ends of the bracket portions 34.11 and 34.21 each engage in the annular groove 310B. In an intermediate position of the fixing bolt 31 taken in this way, the locking elements 34.1, 34.2 thus are in engagement with the fixing bolt 31 and center the same between themselves, as this is illustrated in FIG. 12B. This intermediate position was taken by the fixing bolt 31 for example via a power-operated or manually performed lowering of the interior object, such as the vehicle seat 1, in the direction of the interior surface (fixing surface) I, I*. In this intermediate position, a connector 310D provided at the end of the fixing bolt 31 is not yet in electrically conductive contact with a socket-shaped counter-element 7* arranged below the interior surface I, I*.

A plug connection between the counter-element 7* and the fixing bolt 31 corresponding to FIG. 12C then is reached only by transferring the fixing bolt 31 from the intermediate position into a contacting position. To further lower the fixing bolt 31 for this purpose, the locking elements 34.1 and 34.2 can be driven towards each other via a motor drive 36 for a further adjustment about their pivot axes S1 and S2. At the same time, the pivot axes S1 and S2 of the locking elements 34.1 and 34.2 are shiftably mounted, for example via corresponding slotted link guides, so that the locking elements 34.1 and 34.2 with their bracket portions 34.11 and 34.21 engaging the annular groove 310B can further lower the fixing bolt 31 in a power-operated way and plug the same to the counter-element 7*—by shifting the pivot axes 51, S2 radially to the outside (with respect to the adjustment axis of the fixing bolt 31). Due to being centered via the locking elements 34.1 and 34.2, plug contacts of the fixing bolt 31 and of the counter-element 7* already are aligned with each other. Thus, a tolerance compensation within the plug connection can be kept to a minimum.

In the present case, a permitted pivot angle of the locking elements 34.1 and 34.2 about their respective pivot axis S1 and S2 or an adjustment path realized thereby can be chosen larger than a maximum required path in order to tension the respective interior object in the direction of the interior surface I, I*. In this way, a tolerance compensation is possible for the interior object with a plurality of fixing bolts 31.

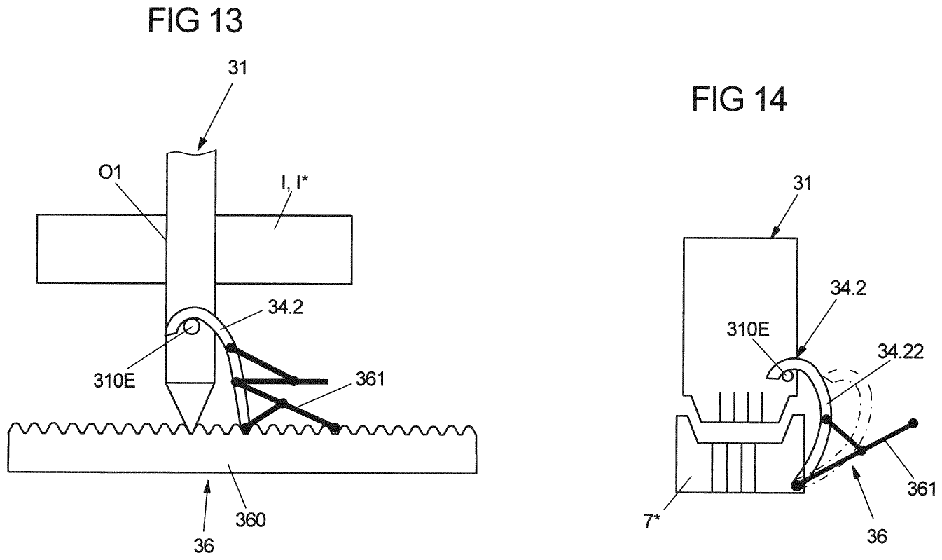

In the design variants of FIGS. 13 and 14, an individual locking element 34.1 each does not engage an annular groove 310B of the fixing bolt 31, but a radially protruding adjusting pin 310E of the fixing bolt 31, in order to displace the fixing bolt 31 from the intermediate position into the contacting position. In the design variant of FIG. 13, the drive 36 is configured with a toothed rack 360 and a lever mechanism 361 for the adjustment of the locking element 34.2. In the design variant of FIG. 14, there is in turn provided a lever mechanism 361 guided by a slotted link for the adjustment of the locking element 34.2.

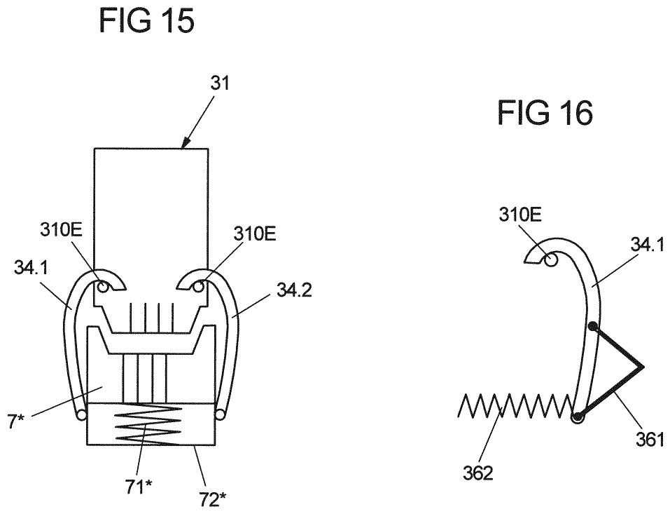

The design variant of FIG. 15 provides that the counter-element 7* with its connector is shiftably mounted in a socket 72* and pretensioned in the direction of the fixing bolt 31 via a compression spring 71*. This can be used to further support the production of the plug connection.

In the sectionally shown design variant of FIG. 16, a locking element 34.1 is pretensioned via a tension spring 362 in that swivel direction opposite to which the locking element 34.1 is brought in engagement with the fixing portion 310 by action of the fixing bolt 31. Via the tension spring 362, the locking element 34.2 automatically can again be disengaged from the fixing bolt 31 when no more counteracting adjusting force is applied onto the locking element 34.2 via the drive 36 and the fixing bolt 31 shall be removed from the fixing opening O1.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1, 1a, 1b, 1c vehicle seat (interior object)

10 backrest (adjustment part)

11 seat part (adjustment part)

12 base

120 drive motor

121 battery

122 connector

123 coupling portion

12A drive device

2.1, 2.2 omniwheel

20 roller support

21 roller

3 fixing device

31, 31′ fixing bolt (fixing element)

31A drive portion

310A introduction cone

310B annular groove (engagement area)

310C contact/plug sleeve

310D connector

310E adjusting pin

317 coupling area

32 fixing bolt (fixing element)

33 locking unit

330 base

330.1B, 330.2B connecting arm

330.3B bearing pin

330A guide part

330B support part

331 carriage guide

34 locking carriage (locking element)

34.1, 34.2 locking element

34.11, 34.21 bracket portion

34.12, 34.22 stop

340 locking plate

341 locking opening

341A, 341B opening portion

342 clamping portion

342.1 release area

342.2 ramp area

342.3 clamping area

34A support sleeve

34B compression spring (spring element)

35, 35A, 35B guide rail

36 drive

36A electric motor unit

36B spindle

360 toothed rack

361 lever mechanism

362 tension spring

4, 4a tag (detection element)

5.1-5.4 sensor element

61 receiver unit

65 transmitter unit

7, 7* counter-element

70 closure portion

71, 71* compression spring

72* socket

73 coupling area

8 plug pin (holder)

80 contact head (contact element)

81 arresting base

9 closure element

90 closure portion

91 pivot axis

A, A1, A2 anchor point (fixing position)

AE electronic evaluation unit

B width

D detection device

F vehicle

I, I* interior surface (fixing surface)

L length

LF loading sill

O1 fixing opening

P base plate

R direction of displacement

S1, S2 pivot axis

V1, V2 adjustment direction

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A fixing device configured to fix an object to a fixing surface in a vehicle, the fixing device comprising:
at least one fixing element configured to fix the object to the fixing surface and provided with a fixing portion configured to be inserted into a fixing opening along an adjustment axis so that the fixing portion engages the fixing opening; and
at least one locking element separate from the at least one fixing element and configured to lock the at least one fixing element within the fixing opening when the fixing portion engages the fixing opening and configured to block movement of the fixing portion from the fixing opening.

2. The fixing device of claim 1, wherein the at least one locking element is adjustable to a locking position in which the at least one locking element is positively connected to the fixing portion.

3. The fixing device of claim 2, wherein the at least one locking element is configured to move to engage an engagement area of the fixing portion, wherein the engagement area is formed radially inward from an area of the fixing portion disposed adjacent to the engagement area, with respect to the adjustment axis.

4. The fixing device of claim 1, wherein the at least one locking element is rotatably mounted about an axis of rotation extending in a direction parallel or perpendicular to the adjustment axis of the fixing portion.

5. The fixing device of claim 1, wherein the at least one locking element is mounted to and configured to shift along an adjustment direction extending transversely to the adjustment axis of the fixing portion.

6. The fixing device of claim 5, wherein the at least one locking element includes a carriage configured to be shifted.

7. The fixing device of claim 6, wherein the carriage defines the locking opening.

8. The fixing device of claim 7, wherein the carriage is shiftable along the adjustment direction from a release position to a locking position and the locking opening defined by the carriage includes first and second opening portions, wherein when the carriage is in the release position, the fixing portion of the at least one fixing element is disposed in the first opening portion and is configured to be inserted into the locking opening, and subsequently into the second opening portion of the locking opening when the carriage is displaced along the adjustment direction so that the fixing portion of the at least one fixing element engages the second opening portion of the locking opening.

9. The fixing device of claim 6, wherein the carriage is elastically pretensioned towards the adjustment direction.

10. The fixing device of claim 9, further comprising:
at least one spring element configured to elastically pretension the carriage, the at least one spring element is supported by a part of the carriage and by a support part, wherein the support part is adjustable in the adjustment direction.

11. The fixing device of claim 1, wherein the at least one locking element includes at least one clamping portion configured to displace the at least one fixing element so that the fixing portion inserted into the fixing opening is configured to be displaced along the adjustment axis to a tensioning position.

12. The fixing device of claim 11, wherein the clamping portion includes a ramp area extending along an inclination with respect to the adjustment axis of the at least one fixing element, wherein the ramp area is adjustable along an engagement area of the fixing portion of the at least one fixing element inserted into the fixing opening, and wherein during an adjustment of the locking element to a locking position, the ramp area displaces the at least one fixing element to the tensioning position by sliding along the engagement area.

13. The fixing device of claim 1, further comprising:
a counter-element configured to be contacted by the fixing portion inserted into the fixing opening in order to produce an electrical connection.

14. The fixing device of claim 1, further comprising:
an adjustably mounted counter-element configured to be adjusted to a closing position, in which the adjustably mounted counter-element at least partially closes the fixing opening, and configured to be displaced from the closed position by inserting the fixing portion into the fixing opening.

15. The fixing device of claim 14, wherein the counter-element is configured to be displaced by the fixing portion from the closed position along the adjustment axis to an adjustment position, when the fixing portion of the at least one fixing element is inserted into the fixing opening.

16. The fixing device of claim 13, wherein displacement of the counter-element from a closed position produces the electrical connection between the fixing portion and the counter-element.

17. The fixing device of claim 16, wherein the counter-element includes a contact element, wherein the contact element is accessible to produce the electrical connection when the counter-element is displaced from the closed position.

18. The fixing device of claim 17, wherein contact element is configured to be inserted into a sleeve-shaped portion of the fixing portion to produce the electrical connection.

19. A fixing device configured to fix an object to a fixing surface in a vehicle, the fixing device comprising:
at least one fixing element configured to fix the object to the fixing surface and provided with a fixing portion configured to be inserted into a fixing opening along an adjustment axis; and
at least one adjustable locking element separate from the at least one fixing element, wherein the at least one adjustable locking element is configured to engage the fixing portion, disposed in an intermediate position, and engage the fixing opening in order to displace the fixing portion from the intermediate position to a contacting position in which the fixing portion is connected to a counter-element to provide an electrical connection.

20. The fixing device of claim 19, wherein the at least one locking element is rotatably mounted about a pivot axis, wherein the pivot axis extends in a direction perpendicular to the adjustment axis of the at least one fixing element and includes a curved bracket portion configured positively engage the fixing portion.

21. The fixing device of claim 19, wherein the at least one locking element includes a first locking element and a second locking element forming a gap configured to receive and center the fixing portion to displace the fixing portion from the intermediate position to the contacting position.

22. A vehicle comprising:
a body-mounted fixing surface;
an object configured to be fixed to the body-mounted fixing surface;
at least one fixing device configured to fix the object to the fixing surface, wherein the at least one fixing device includes,
at least one fixing element configured to fix the object to the fixing surface and provided with a fixing portion configured to be inserted into a fixing opening along an adjustment axis so that the fixing portion engages the fixing opening, and
at least one locking element separate from the at least one fixing element and configured to lock the at least one fixing element within the fixing opening when the fixing portion engages the fixing opening and configured to block movement of the fixing portion from the fixing opening.

23. The vehicle of claim 22, wherein the at least one fixing device is configured to be disposed on the fixing surface or on the object.

24. The vehicle of claim 22, further comprising:
an electronic detection device, wherein the fixing surface is provided in a vehicle interior of the vehicle, and the electronic detection device is configured to detect a position of the object on an interior surface.

25. The vehicle of claim 24, wherein
the at least one object includes at least one battery-operated motorized drive device configured to provide a non-mechanically guided displacement of the object on the interior surface of the vehicle,
the at least one fixing element is configured to fix the object in a fixing position on the interior surface, and wherein the electronic detection device is configured to detect the object reaching the fixing position.

26. The vehicle of claim 25, wherein the at least one motorized drive device includes an omnidirectional drive.

27. The vehicle of claim 22, wherein the object includes a vehicle seat, a console, and/or a battery carrier.

28. The vehicle of claim 27, wherein the vehicle seat includes the at least one fixing device, and the at least one fixing device is configured to fix the vehicle seat to an interior surface of the vehicle.

29. The vehicle of claim 27, wherein the battery carrier includes at least one battery cell, configured to power a vehicle, and the at least one fixing device is configured to fix the battery carrier within the vehicle.
